(19) United States
(12) Patent Application Publication
(10) Pub. No.: US 2025/0382476 A1
(43) Pub. Date: Dec. 18, 2025

(54) SUPERHYDROPHOBIC COATINGS

(71) Applicants: THE STATE OF ISRAEL, MINISTRY OF AGRICULTURE & RURAL DEVELOPMENT, AGRICULTURAL RESEARCH, Rishon Lezion (IL); BAR-ILAN UNIVERSITY, Ramat Gan (IL)

(72) Inventors: Guy MECHREZ, Adi (IL); Karthik Ananth MANI, Rishon Lezion (IL); Raz COHEN, Tel -Aviv (IL); Madina PIRMATOVA, Rishon Lezion (IL); Yifat BAREKET, Reut (IL); Ehud BANIN, Tel-Aviv (IL)

(21) Appl. No.: 18/875,157

(22) PCT Filed: Jun. 14, 2023
(86) PCT No.: PCT/IL2023/050618

§ 371 Date: Dec. 15, 2024

Related U.S. Application Data
(60) Provisional application No. 63/352,055, filed on Jun. 14, 2022.

(51) Int. Cl. C09D 5/03; B05D 3/02; C09D 5/14; C09D 7/40; C09D 7/62; C09D 7/65

(52) U.S. Cl. CPC C09D 5/031; B05D 3/0254; C09D 5/14; C09D 7/62; C09D 7/65; C09D 7/67; B05D 2601/20

(57) ABSTRACT

A composition comprising an emulsion comprising a plurality of particles is provided. An article comprising a substrate, and a plurality of particles comprising a void core and a shell, wherein the plurality of particles are in the form of a coating layer on the substrate is provided. Further, a method for coating a substrate is provided.

### CROSS REFERENCE TO RELATED APPLICATIONS

This application claims the benefit of priority from U.S. Provisional Patent Application No. 63/352,055, filed Jun. 14, 2022. The contents of the above are all incorporated herein by reference as if fully set forth herein in their entirety.

### FIELD OF THE INVENTION

The present invention is in the field of Pickering emulsions and use thereof such as superhydrophobic coatings.

### BACKGROUND OF THE INVENTION

The current world population is 7.9 billion as of November 2021, according to the most recent United Nations estimates elaborated by Worldometer. The value is expected to reach 9 billion in the year 2037. In Europe, a total of 5,146 food-borne and water-borne outbreaks, including 48,365 cases of illness and 40 deaths, were reported to the European Food Safety Authority (EFSA) in 2018. Given these facts, humanity will face severe food insecurity and an increase in the number of diseases associated with food poisoning for the coming decades. To meet the ongoing problem, prevention of food contamination with pathogens needs. Such a solution will contribute to maintaining productivity in the food industries and those who are constantly faced with the disposal of products that are not usable due to the activity of microorganisms and biofilm formation.

Pickering emulsions are typically known as emulsions of any type, for example oil-in-water or water-in-oil, stabilized by solid particles in place of surfactants. Pickering emulsions are stabilized by nanoparticles (NPs) that are self-assembled typically at the oil-water interface and acts as a physical barrier.

Currently, Pickering emulsion are mostly based on aromatic solvents such as toluene and xylene, as the oil phase. However, aromatic solvents are known for enhanced toxicity, and thus have a limited utility for large-scale industrial processes. Accordingly, there is an unmet need to develop new anti-biofilm coatings based on less toxic organic solvents, which are appropriate for industrial applications.

### SUMMARY OF THE INVENTION

In one aspect, there is a composition, comprising a core-shell particle dispersed within a hydrophobic solvent, wherein the core of said core-shell particles comprises an aqueous solution; the shell of said core-shell particles comprises hydrophobic metal oxide nanoparticles and polymeric particles; a w/w ratio of said hydrophobic solvent to said aqueous solution within said composition is between 6:4 and 10:1; and a w/w concertation of the hydrophobic metal oxide nanoparticles within said composition is between 0.5 and 5%; an average cross-section of the core-shell particles is between 1 μm and 100 μm; and a ratio between the hydrophobic metal oxide nanoparticles and the polymeric particles is between 30:1 and 1:1; and the hydrophobic solvent is or comprises dimethyl carbonate (DMC).

In one embodiment, a w/w concertation of the hydrophobic metal oxide nanoparticles within said composition is between 1.5 and 3%.

In one embodiment, a w/w concertation of the polymeric particles within the composition is between 0.5 and 3%.

In one embodiment, an average cross-section of said polymeric particles is between 1 nm and 10 um.

In one embodiment, hydrophobic metal oxide nanoparticles comprise a chemical modification covalently attached to a metal oxide particle, the metal oxide particle is or comprises SiO₂ particle.

In one embodiment, chemical modification comprises any of a polysiloxane, a polysilane, (C1-C20)alkylsilyl group, a (C1-C20)alkoxysilane group including any copolymer or any combination thereof.

In one embodiment, polysiloxane comprises PDMS.

In one embodiment, the polymeric particles are configured to undergo coalescence at a temperature between 2° and 90° C.; and wherein the polymeric particles are latex nanoparticles comprising a thermoplastic polymer characterized by a glass transition temperature between 1° and 90° C.

In one embodiment, the thermoplastic polymer comprises a polyacrylate, a polyester, a polyurethane, including any derivative or any copolymer thereof.

In another aspect, there is provided a coated substrate, comprising at least one surface of a substrate in contact with a coating, wherein: the coating comprises a plurality of hollow microparticles; a shell of the hollow microparticles comprises hydrophobic metal oxide nanoparticles and a thermoplastic polymer; a ratio between the hydrophobic metal oxide nanoparticles and the thermoplastic polymer within the shell is between 30:1 and 1:1. In one embodiment, the coated substrate is characterized by a water contact angle of at least 1200.

In one embodiment, the coated substrate has a roll-off angle between 0 and 10°.

In one embodiment, the substrate comprises a plastic substrate, a cellulose-based substrate (e.g. wood, paper, etc.), a glass substrate, a ceramic substrate, a metal substrate (e.g. aluminum), a textile substrate, and a wood substrate or any combination thereof.

In one embodiment, hydrophobic metal oxide nanoparticles comprise a chemical modification covalently attached to a metal oxide particle, the metal oxide particle is selected from nanoclay, SiO₂, TiO₂, Al₂O₃, Fe₂O₃, ZnO, and ZrO or any combination thereof.

In one embodiment, chemical modification comprises any of a polysiloxane, a polysilane, (C1-C20)alkylsilyl group, a (C1-C20)alkoxysilane group including any copolymer or any combination thereof.

In one embodiment, polysiloxane comprises PDMS.

In one embodiment, the coating is in a form of a continuous layer, characterized by a thickness of between 0.5 and 50 um.

In one embodiment, an outer surface of the coated substrate is characterized by a route mean square of surface height (RMS) of between 20 and 100 nm.

In one embodiment, the coated substrate is characterized by an abrasion stability, as determined by tape test or by sandpaper test.

In one embodiment, the hydrophobic metal oxide nanoparticles are embedded within a matrix of the thermoplastic polymer, and wherein a ratio between the hydrophobic metal oxide nanoparticles and the thermoplastic polymer within the coating is between 25:1 and 5:1.

In another aspect, there is provided a method of fabricating the coated substrate of the invention, comprising applying the composition of the invention on top of a substrate; and exposing the substrate in contact with the composition to a temperature above the glass transition point of the polymeric particles, thereby obtaining the coated substrate.

In one embodiment, the temperature is between 25 and 200° C.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a bar graph showing droplet diameter (μm) vs oil-in-water emulsion ratios formed in various fractions of DMC and 1 wt. % concentration of latex polymer.

FIG. 2 is a bar graph showing droplet diameter (μm) vs oil-in-water or water-in-oil emulsions ratios formed in various fractions of toluene and water and 1 wt % concentration of latex polymer stabilized by 1 wt % silica nanoparticles, where the black bars refer to day 1, and white bars refer to day 5 for the same tracking emulsions.

FIGS. 3A-3B are CryoSEM images at different magnification presenting oil-in-water DMC and water (8:2) based emulsion with latex polymer 1 wt % % stabilised by 1 wt. % hydrophobic silica. Scale bar (3A) 10 μm, (3B) 1 μm.

FIGS. 4A-4B are CryoSEM images at different magnification presenting oil-in-water DMC and water (7:3) based emulsion with latex polymer 1 wt % % stabilised by 1 wt. % hydrophobic silica. Scale bar (4A) 1 μm, (4B) 10 μm.

FIGS. 5A-5C are micrographs presenting SEM (5A) analysis and AFM (5B-C) analysis at different magnification of the resulting coatings based on DMC-water (o/w ratio, 8:2) emulsion. Coating prepared on PP surface.

FIGS. 6A-6F are micrographs presenting SEM (6A-D) and AFM (6E-F) analysis at different magnification of the resulting coatings based on DMC-water (o/w ratio, 8:2) emulsion stabilized by 2 wt % silica. Coating prepared on PP (polypropylene) surface.

FIG. 7 is a bar graph showing water contact angle values of the exemplary aqueous emulsions applied on the PP surface as a function of DMC:latex ratio.

FIGS. 8A-8B are images presenting polypropylene surface coated with an emulsion comprising DMC: Latex in DDW at a ratio 8:2 without silica particles (8A) and with 2% hydrophobic silica nanoparticles (8B).

FIG. 9 is a bar graph showing droplet diameter (μm) vs days of the coating based on water-in-oil emulsion in ratio of 8:2 that formed of DMC and 1 wt % of latex polymer and stabilized by 2 wt % hydrophobic silica nanoparticles.

FIGS. 10A1-10A5 and FIG. 10B are images presenting wettability of paper substrates treated by DMC based emulsions with different oil:water ratios with latex polymer, stabilized by 0, 1 and 2 wt % silica mass fractions, 9:1 oil:water ratio stabilized by 1 wt % silica (10A1), 9:1 oil:water ratio stabilized by 2 wt % silica (10A2), 8:2 oil:water ratio stabilized by 1 wt % silica (10A3), 8:2 oil:water ratio stabilized by 2 wt % silica (10A4), 9:1 oil:water ratio without silica (10A5); contact angle of the coated paper substrate according to the invention (10B, right) versus an untreated control sample (10B, left).

FIGS. 11A-11B are images presenting paper surface coated by toluene and 1 wt % Latex PRIMER 1853 polymer emulsion in 7:3 ratio with hydrophobic silica 2 wt %: (11A) before abrasion test; (11B) after abrasion test.

FIG. 12 is a bar graph presenting anti-biofilm activity of the developed superhydrophobic surfaces. Polypropylene and paper surfaces coated with toluene and DMC system in ratio 8:2 (oil:water) with various latex content and 2 wt % silica NPs. The data shown represent the average of two independent experiments.

FIGS. 13A-13F are images presenting the structure and position of the two types of particles on the droplet: (13A) Cryo-SEM micrograph of a single droplet, (13B) confocal image of a single droplet, (13C) Cryo-SEM micrograph of several droplets, (13D) confocal image of several droplets, (13E) schematic representation the role of each particle (silica and latex) in the stabilization of water in DMC, wherein dashed spheres represent particles substantially devoid of latex, (13F) 3D confocal image of water in DMC stabilized by silica and latex using Latex PRIMER 1853 1 wt %, and 2 wt % R202 silica NPs.

FIGS. 14A1-A5; 14B1-14B5; and 14C1-14C5 are fluorescence images and a schematic illustration presenting the templating process of the studied formulation on a glass slide: (14A1, 14B1 and 14C1) fluorescence imaging of Latex particles at the emulsion deposition, 30 seconds after emulsion deposition, and 60 seconds after emulsion deposition on a glass slide, respectively, (14A2, 14B2 and 14C2) fluorescence imaging of Silica particles at the emulsion deposition, 30 seconds after emulsion deposition, and 60 seconds after emulsion deposition on a glass slide, respectively, (14A3, 14B3 and 14C3) fluorescence imaging of DMC droplets at the emulsion deposition, 30 seconds after emulsion deposition, and 60 seconds after emulsion deposition on a glass slide, respectively, (14A4, 14B4 and 14C4) fluorescence imaging of merged labeled medium and particles, at the emulsion deposition, 30 seconds after emulsion deposition, and 60 seconds after emulsion deposition on a glass slide, respectively, and (14A5, 14B5 and 14C5) schematic illustration of the templating process at the emulsion deposition, 30 seconds after emulsion deposition, and 60 seconds after emulsion deposition on a glass slide, respectively.

FIGS. 15A, 15B1-15B3, 15C1-15C3, 15D-15F are graphs and micrographs presenting water permeability and mechanical properties of coated paper: (15A) weigh dependency in submersion time of a uncoated paper, a coated paper with Latex dispersion in water and with an exemplary composition of the invention (termed as SHC=superhydrophobic coating); SEM images of uncoated paper (15B1), coated paper with latex dispersion in water(15B2) and SHC(15B3), respectively; confocal 3D Z-stack images of uncoated paper substrate (15C1), paper coated with latex dispersion in water (15C2) and SHC (15C3); (15D) Tensile strength of uncoated paper, coated paper and SHC, (15E) Young modulus of uncoated paper, coated paper and SHC, and (15F) Tensile strain at break of uncoated paper, coated paper and SHC.

FIGS. 16A-16B are bar graphs and images presenting superhydrophobic performance and contact angle (CA) analysis of a paper substrate coated by an exemplary composition of the invention. (16A) is a bar graph presenting a correlation between static CA vs temperature of a water drop deposited on the coated paper substrate, and (16B) advancing and receding contact angle of the coated paper substrate.

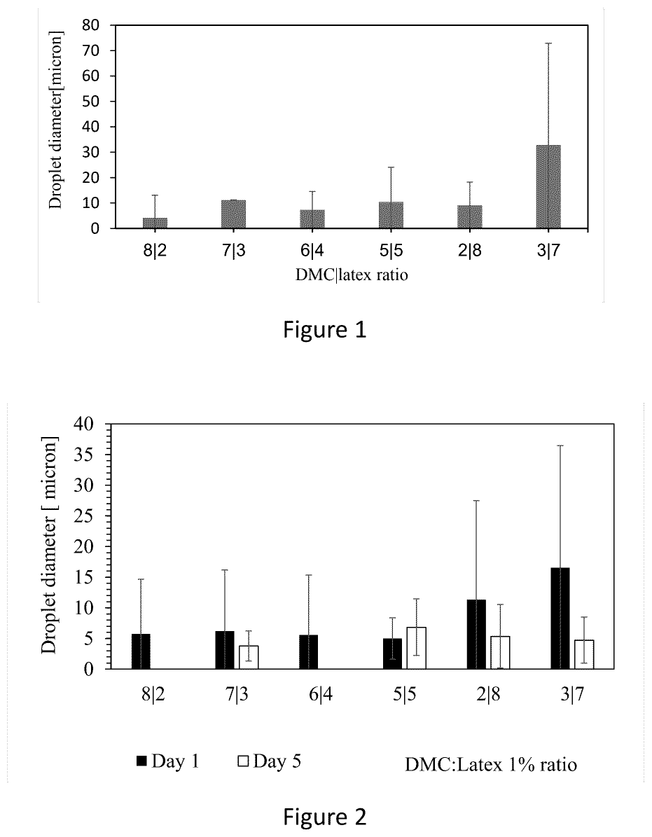

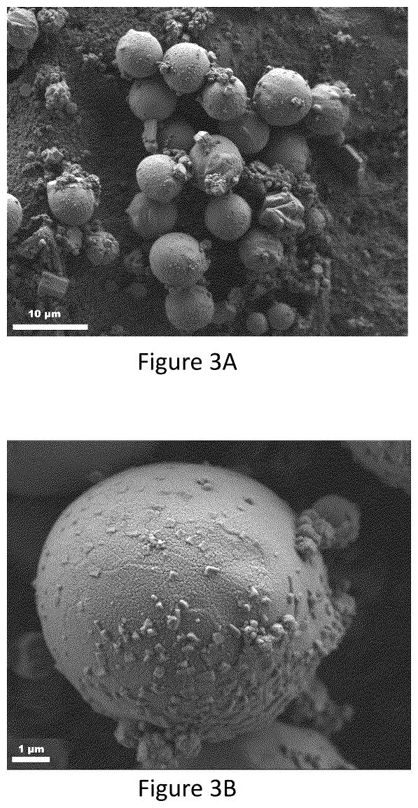

### DETAILED DESCRIPTION OF THE INVENTION

According to some embodiments, the present invention provides a coating composition comprising a plurality of core-shell particles, wherein the particle core comprises a liquid, and wherein a shell of the particles comprises hydrophobic metal oxide nanoparticles in contact with polymeric particles. In some embodiments, the composition comprises a water-in-oil (W/O) Pickering emulsion. In some embodiments, the composition comprises an oil-in-water (O/W) Pickering emulsion. The emulsions according to the present invention comprise microparticles comprising a shell of hydrophobic metal oxide (e.g., silica) nanoparticles in contact with polymeric particles, and a core comprising an aqueous solution. In some embodiments, the emulsions are used as active coatings. In some embodiments, the polymeric particles are polymeric nanoparticles.

According to some embodiments, the present invention provides a composition comprising a core-shell particle dispersed within a hydrophobic solvent, wherein a core of the core-shell particles comprises an aqueous solution; a shell of the core-shell particles comprises hydrophobic metal oxide nanoparticles; wherein the hydrophobic metal oxide nanoparticles are in contact with polymeric particles, wherein the a hydrophobic metal oxide nanoparticles are surface modified hydrophobic metal oxide nanoparticles (e.g. surface modified silica nanoparticles); and a w/w concertation of the hydrophobic metal oxide nanoparticles within said composition is between 0.5 and 5%; and wherein a ratio between the hydrophobic metal oxide nanoparticles and the polymeric particles is between 30:1 and 1:1.

In some embodiments, the shell is a single layer shell. In some embodiments, the single layer shell comprises or consists essentially of the hydrophobic metal oxide nanoparticles. In some embodiments, the shell comprises a plurality of distinct layers, wherein each layer comprises the hydrophobic metal oxide nanoparticles or the polymeric particles. In some embodiments, the hydrophobic metal oxide nanoparticles are in the interface between a major phase and a minor phase. In some embodiments, the hydrophobic metal oxide nanoparticles are in the interface and form an inner layer of the core-shell particle, and wherein the inner layer faces and encloses the core and is further in contact with an outer layer (e.g. a concentric or non-concentric outer layer bound only to a part of the inner layer). In some embodiments, the hydrophobic metal oxide nanoparticles and the polymeric particles stabilize the composition (e.g., emulsion or dispersion). In some embodiments, the polymeric particles are dispersed in the major phase. In some embodiments, the polymeric particles are in contact with one or more core-shell particles. In some embodiments, the polymeric particles bridge/connect between two or more core-shell particles. In some embodiments, the polymeric particles in contact with the core-shell particles are in a form of a matrix composed of a network of bridges connecting or in contact with two or more core-shell particles. In some embodiments, each bridge is an agglomerate of the polymeric particles.

In some embodiments, the hydrophobic metal oxide nanoparticles comprise silica nanoparticles modified with a polysiloxane. In some embodiments, a w/w concertation of the polymeric particles within the composition is between 0.5 and 3%. In some embodiments, the particles comprise a shell encapsulating an aqueous core.

According to some embodiments, the present invention provides an article comprising a substrate coated by the coating composition of the invention. In some embodiments, the article comprises a coated substrate comprising a coating layer on top and in contact with the substrate, wherein the coating layer comprises a polymeric matrix and the hydrophobic metal oxide nanoparticles embedded on or within the polymeric matrix, and wherein the polymeric matrix and the polymeric particles of the coating composition are composed of the same polymer.

In some embodiments, the coating layer is an active coating (e.g., characterized by reduced microbial load, and/or preventing microbial attachment thereto). In some embodiments, the coating layer is formed upon application of the coating composition of the invention on the surface and drying. In some embodiments, the article comprising the coating layer (i.e., the outer surface of the coating) is characterized by anti-microbial properties, anti-fogging properties, water repellant properties, oleophobic properties etc. In some embodiments, the outer surface of the article (i.e., coated surface) is printable.

In some embodiments, the coating is stable (e.g., maintains at least 90% of its surface roughness, shape, dimensions, and/or chemical composition) upon mechanical abrasion.

### The Composition

In one aspect of the invention, there is a composition comprising an emulsion or a dispersion. In some embodiments, the emulsion is an O/O Pickering emulsion. In some embodiments, the emulsion is a W/O Pickering emulsion. In some embodiments, the emulsion is an O/W Pickering emulsion.

In some embodiments, the composition of the invention comprises an emulsion or dispersion, comprising a plurality of core-shell particles, having a diameter of 1 μm to 100 μm, the core-shell particles comprise a shell comprising hydrophobic metal oxide nanoparticles in contact with polymeric particles; a w/w ratio of said hydrophobic solvent to said aqueous solution within said composition is between 6:4 and 10:1; a w/w concertation of the hydrophobic metal oxide nanoparticles within said composition is between 0.5 and 5%; an average cross-section of the core-shell particles is between 1 μm and 100 μm; and a ratio between the hydrophobic metal oxide nanoparticles and the polymeric particles is between 30:1 and 1:1. In some embodiments, the composition of the invention is as described above, wherein the hydrophobic solvent is or comprises dimethyl carbonate (DMC).

In some embodiments, the composition of the invention comprises core-shell particles dispersed within a hydrophobic solvent, wherein each of the core-shell particles comprises a core enclosed by a shell; wherein the core comprises an aqueous solution; the shell comprises hydrophobic metal oxide nanoparticles; wherein at least a portion of the hydrophobic metal oxide nanoparticles is in contact with polymeric particles, a w/w ratio of said hydrophobic solvent to said aqueous solution within said composition is between 6:4 and 10:1; an average cross-section of the core-shell particles is between 1 μm and 100 μm; and a ratio between the hydrophobic metal oxide nanoparticles and the polymeric particles within the composition is between 30:1 and 5:1. In some embodiments, a w/w concertation of the hydrophobic metal oxide nanoparticles within said composition is between 0.1 and 10%.

In some embodiments, the composition of the invention is an emulsion or dispersion, comprising a plurality of core-shell particles (e.g., droplets), wherein the core-shell particles consist essentially of an aqueous core; and of hydrophobic metal oxide nanoparticles in contact with polymeric particles forming or defining the shell.

In some embodiments, the composition of the invention comprises an emulsion or dispersion, comprising a plurality of particles, wherein the particles are in the form of droplets. In some embodiments, the particles are in the form of core-shell particles (e.g., each particle comprises a shell and a core).

In some embodiments, the composition of the invention is a fluid at a temperature between −30 and 90° C., between −30 and 40° C., between −30 and 50° C., between −30 and 70° C., including any range between. In some embodiments, the composition of the invention is a liquid at a temperature between −30 and 90° C., between −30 and 40° C., between −30 and 50° C., between −30 and 70° C., including any range between.

As used herein, the term “Pickering emulsion” refers to an emulsion that utilizes solid particles as a stabilizer to stabilize droplets of a substance, in a dispersed phase in the form of droplets dispersed throughout a continuous phase.

As used herein, the term “emulsion” refers to a combination of at least two fluids, where one of the fluids is present in the form of droplets in the other fluid. The term “emulsion” includes microemulsions.

As used herein, the term “fluid” refers to a substance that tends to flow and to conform to the outline of its container, i.e., a liquid, a gas, a viscoelastic fluid, etc. Typically, fluids are materials that are unable to withstand static shear stress, and when a shear stress is applied, the fluid experiences a continuing and permanent distortion. The fluid may have any suitable viscosity that permits flow. If two or more fluids are present, each fluid may be independently selected among essentially any fluids (liquids, gases, and the like) by those of ordinary skill in the art, by considering the relationship between the fluids. In some cases, the droplets may be contained within a carrier fluid, e.g., a liquid.

In some embodiments, the composition comprises a hydrophobic solvent, selected from an aliphatic organic solvent, an aromatic organic solvent, a ketone-based solvent, an ether-based solvent, an ester-base solvent, a halogenated solvent, or any combination thereof. In some embodiments, the hydrophobic solvent is substantially devoid of a halogenated solvent.

In some embodiments, the hydrophobic solvent is water immiscible. In some embodiments, the hydrophobic solvent is characterized by water solubility of less than 1 g/1 L, less than 0.1 g/1 L, less than 0.01 g/1 L, less than 0.001 g/1 L, including any range therebetween at a temperature between 2° and 27° C.

In some embodiments, the hydrophobic solvent is characterized by w/w water solubility of between 0.1% and 15%, between 1% and 15%, between 5% and 15%, between 10% and 15%, between 12% and 14%, between 5% and 14%, including any range therebetween.

In some embodiments, the hydrophobic solvent is characterized by a dipole moment of less than 1.8, less than 1.5, less than 1.3, less than 1.0, less than 0.8, less than 0.6, less than 0.4, less than 0.2, less than 0.1, including any range therebetween.

In some embodiments, the hydrophobic solvent is characterized by a dipole moment of between 0 and 0.5, between 0.5 and 1, between 1 and 1.5, including any range therebetween.

In some embodiments, the hydrophobic solvent is characterized by a dipole moment and by water solubility as described hereinabove.

In some embodiments, the hydrophobic solvent is devoid of additional non-hydrophobic solvents. In some embodiments, the fluid consists essentially of the hydrophobic solvent. In some embodiments, the hydrophobic solvent refers to any known hydrophobic solvent being utilized in a chemical and/or pharmaceutical industry. In some embodiments, the hydrophobic solvent is substantially devoid of an additional liquid. In some embodiments, the hydrophobic solvent comprises a plurality of hydrophobic solvents (e.g., a mixture of solvents).

Non-limiting examples of hydrophobic solvents (e.g., aliphatic hydrocarbons) include but are not limited to: pentane, hexane, cyclohexane, octane, heptane, or any combination thereof. Other aliphatic hydrocarbon solvents are well known in the art, such as ethyl ether, methyl ethyl ketone (MEK), methylisobutylketone, dichloromethane, chloroform, aliphatic esters (such as ethyl acetate).

Non-limiting examples of hydrophobic solvents (e.g., aromatic hydrocarbons) include but are not limited to toluene, ethylbenzene, xylene, chlorobenzene, styrene, dichlorobenzene, nitrobenzene, trimethylbenzene, trichlorobenzene or any combination thereof. In some embodiments, the composition of the invention is substantially devoid of chlorinated solvents, fluorinated solvents, or both. In some embodiments, the hydrophobic solvent is or comprises dimethyl carbonate (DMC).

In some embodiments, the composition further comprises an effective amount of the active agent. In some embodiments, the effective amount is an antimicrobially effective amount (i.e. an amount sufficient for reducing, preventing, or eradicating microbial load on a surface of a substrate coated by the composition/dry coating of the invention). In some embodiments, the effective amount is a plant protective amount (i.e. an amount sufficient for reducing, preventing, or eradicating a plant pest on or within the area under cultivation in close proximity to an article of the invention the composition/dry coating of the invention, such as a greenhouse having at least one wall in contact with the composition/dry coating of the invention). In some embodiments, the effective amount comprises a concentration of the active agent within the composition ranging between 0.1% and 20%, between 0.1% and 5%, between 5% and 10%, between 10% and 20%, between 0.1% and 15%, between 0.1% and 10%, between 1% and 5%, between 1% and 10%, (w/w), including any range therebetween.

In some embodiments, the effective amount refers to a concentration of the active agent within the composition sufficient for providing the composition with an antimicrobial activity. In some embodiments, the active agent is an anti-microbial agent. In some embodiments, the active agent is dissolved or dispersed within the major phase (i.e. the hydrophobic solvent of the composition). In some embodiments, the active agent is dissolved with DMC. In some embodiments, the anti-microbial agent is selected from a wax (e.g., a natural wax such as propolis), fatty aldehyde (such as compounds listed in Table 3) and/or an essential oil.

Non-limiting examples of essential oil include but are not limited to tea tree oil, eucalyptus oil, lemongrass oil, thymol, or carvacrol, including any combination thereof.

In some embodiments, the core-shell particle of the invention comprises an aqueous core and an amphiphilic shell. In some embodiments, the core-shell particle is in a form of a colloidosome.

In some embodiments, the core-shell particle has a spherical geometry or shape. In some embodiments, the core-shell particle has an inflated or a deflated shape. In some embodiments, a plurality of core-shell particles is devoid of any characteristic geometry or shape. In some embodiments, the core-shell particle has a spherical shape, a quasi-spherical shape, a quasi-elliptical sphere, a deflated shape, a concave shape, an irregular shape, or any combination thereof.

In some embodiments, the plurality of core-shell particles are substantially spherically shaped, wherein substantially is as described herein. In some embodiments, the plurality of core-shell particles is substantially elliptically shaped, wherein substantially is as described herein. One skilled in the art will appreciate that the exact shape of each of the plurality of core-shell particles may differ from one particle to another. Moreover, the exact shape of the core-shell particle may be derived from any of the geometric forms listed above, so that the shape of the particle does not perfectly fit to a specific geometrical form. One skilled in the art will appreciate that the exact shape of the core-shell particle may have substantial deviations (such as at least 5%, at least 10%, at least 20% deviation) from a specific geometrical shape (e.g., a sphere or an ellipse).

In some embodiments, the core-shell particle have a cross-section between 1 μm and 500 μm, 1 μm to 100 μm, 5 μm to 100 μm, 10 μm to 100 μm, 20 μm to 50 μm, 20 μm to 100 μm, 20 μm to 70 μm, 10 μm to 80 μm, 10 μm to 70 μm, 10 μm to 40 μm, 20 μm to 40 μm, 50 μm to 100 μm, 11 μm to 80 μm, 10 μm to 80 μm, 50 μm to 80 μm, 10 μm to 50 μm, 80 μm to 100 μm, 100 μm to 200 μm, 200 μm to 300 μm, 300 μm to 400 μm, 400 μm to 500 μm, 1 μm to 10 μm, 5 μm to 10 μm, 1 μm to 50 μm, 10 μm to 50 μm, 5 μm to 50 μm, or 1 μm to 5 μm, including any range or value therebetween.

In some embodiments, the cross-section of the core-shell particles described herein represents an average cross-section. In some embodiments, the cross-section of the core-shell particle described herein represents an average or median size of a plurality of particles. In some embodiments, the average, or the median size of at least e.g., 10%, 20%, 30%, 40%, 50%, 60%, 70%, 80%, 90%, or 95% of the particles, ranges from: 1 μm to 100 μm, 5 μm to 50 μm, 1 μm to 50 μm, 5 μm to 10 μm, 10 μm to 50 μm, including any range therebetween. In some embodiments, the diameter of the core-shell particle described herein is a dry diameter (i.e., a diameter of isolated dried particles). In some embodiments, a plurality of the core-shell particles has a uniform size. By “uniform” or “homogenous” it is meant to refer to size distribution that varies within a range of less than e.g., ±60%, ±50%, ±40%, ±30%, ±20%, or ±10%, including any value therebetween.

In some embodiments, the core-shell particle is in a form of a droplet.

In some embodiments, a diameter of the droplet is between 1 μm to 100 μm, 5 μm to 100 μm, 10 μm to 100 μm, 50 μm to 100 μm, 1 μm to 80 μm, 10 μm to 80 μm, 50 μm to 80 μm, 1 μm to 10 μm, 5 μm to 10 μm, 1 μm to 50 μm, 10 μm to 50 μm, 5 μm to 50 μm, or 1 μm to 5 μm, including any range therebetween.

As used herein, the term “droplet” refers to an isolated portion of a first fluid that is surrounded by a second fluid. It is to be noted that a droplet is not necessarily spherical; but may assume other shapes as well, for example, depending on the external environment. In some embodiments, the droplet has a minimum cross-sectional dimension that is substantially equal to the largest dimension of the channel perpendicular to fluid flow in which the droplet is located. In some cases, the droplet may be a vesicle, such as a liposome, a colloidosome, or a polymerosome. The fluidic droplets may have any shape and/or size. Typically, monodisperse droplets are of substantially the same size. The shape and/or size of the fluidic droplets can be determined, for example, by measuring the average diameter or other characteristic dimension of the droplets. The “average diameter” of a plurality or series of droplets is the arithmetic average of the average diameters of each of the droplets. Those of ordinary skill in the art will be able to determine the average diameter (or other characteristic dimension) of a plurality or series of droplets, for example, using laser light scattering, microscopic examination, or other known techniques. The average diameter of a single droplet, in a non-spherical droplet, is the diameter of a perfect sphere having the same volume as the non-spherical droplet.

In some embodiments, the average diameter of a droplet (and/or of a plurality or series of droplets) is, 5 μm to 100 μm, 5 μm to 50 μm, 1 μm to 50 μm, including any range therebetween. In some embodiments, the average diameter of a droplet is a wet diameter (i.e., a particle diameter within a solution).

In some embodiments, the core-shell particle of the invention is a droplet. In some embodiments, the core-shell particle of the invention is a colloidosome.

In some embodiments, the core-shell particle comprises between 1% and 10%, between 1% and 15%, between 1% and 13%, between 1% and 10%, between 2% and 10%, between 2% and 3%, between 2% and 5%, between 5% and 10%, between 3% and 10%, between 2% and 7%, between 2% and 6%, (w/w) of the hydrophobic metal oxide nanoparticles including any range therebetween, wherein the core-shell particle is a droplet (e.g., comprises an aqueous core).

In some embodiments, the core-shell particle comprises between 1% and 10%, between 1% and 15%, between 1% and 13%, between 1% and 10%, between 2% and 10%, between 2% and 3%, between 2% and 5%, between 5% and 10%, between 3% and 10%, between 2% and 7%, between 2% and 6%, (w/w) of the polymeric particles including any range therebetween, wherein the core-shell particle is a droplet (e.g., comprises an aqueous core).

In some embodiments, a ratio between the hydrophobic metal oxide nanoparticles and the polymeric particles within the core-shell particle and/or within the composition of the invention is between 30:1 and 1:1, between 30:1 and 1.5:1, between 30:1 and 2:1, between 30:1 and 3:1, between 30:1 and 4:1, between 30:1 and 5:1, between 20:1 and 5:1, between 20:1 and 10:1, between 30:1 and 10:1, between 25:1 and 5:1, between 25:1 and 10:1, between 5:1 and 4:1, between 5:1 and 3:1, between 5:1 and 5:2, between 3:1 and 1.5:1, between 5:1 and 2:1, including any range therebetween.

In some embodiments, a stable composition of the invention comprises substantially hollow-sphere core-shell particles. In some embodiments, a stable composition of the invention comprises between 30 and 70%, between 30 and 50%, between 40 and 70%, between 40 and 60%, between 30 and 60%, between 50 and 70%, between 50 and 60% by weight of the core-shell particles including any range therebetween.

In some embodiments, the hydrophobic metal oxide nanoparticles are bound to or are in close proximity to the polymeric particles within the shell. In some embodiments, the hydrophobic metal oxide nanoparticles are mixed with the polymeric particles within the shell. In some embodiments, bound is via non-covalent bonds or interactions. In some embodiments, bound is adsorption (physisorption). In some embodiments, bound is via non-ionic physical bond or interaction. In some embodiments, the shell is composed of a single layer. In some embodiments, the shell is composed of a plurality of distinct layers. In some embodiments, the shell comprises a first layer composed essentially of the metal oxide nanoparticles; and a second layer composed essentially of the polymeric particles.

In some embodiments, the shell is in a form of a layer. In some embodiments, the shell is in a form of a uniform layer. In some embodiments, the shell is in a form of a homogenous layer. In some embodiments, the hydrophobic metal oxide nanoparticles and the polymeric particles are homogenously distributed within the entire volume of the shell. In some embodiments, at least a portion of the hydrophobic metal oxide nanoparticles and/or of the polymeric particles is located in contact with or within the core. In some embodiments, between 50 and 99.9%, between 60 and 99.9%, between 70 and 90%, between 80 and 95% by the combined weight of the hydrophobic metal oxide nanoparticles and the polymeric particles is located within the interphase of the composition (or within the shell of the core-shell particle).

In some embodiments, the hydrophobic metal oxide nanoparticles and the polymeric particles constitute up to 80%, up to 85%, up to 90%, up to 92%, up to 95%, up to 97%, up to 99%, up to 98%, up to 96% w/w of the core-shell particle's shell. In some embodiments, the hydrophobic metal oxide nanoparticles and the polymeric particles constitute up to 80%, up to 85%, up to 90%, up to 92%, up to 95%, up to 97%, up to 99%, up to 98%, up to 96% of the total dry weight of the core-shell particle.

In some embodiments, the shell consists essentially of the hydrophobic metal oxide nanoparticles. In some embodiments, the hydrophobic metal oxide nanoparticles constitute up to 80%, up to 85%, up to 90%, up to 92%, up to 95%, up to 97%, up to 99%, up to 98%, up to 96%, or between 70 and 99%, between 80 and 95%, between 70 and 95% of the total surface of the shell. In some embodiments, the shell consists essentially of the hydrophobic metal oxide nanoparticles and the polymeric particles are dispersed or distributed within the major phase (i.e. the hydrophobic solvent). In some embodiments, the polymeric particles are in a form of particle agglomerates bridging between the neighboring core-shell particles (and in contact with the shell).

In some embodiments, the shell comprises an inner portion facing the core-shell particle's core (e.g., aqueous core) and an outer portion facing the major phase (e.g., the hydrophobic solvent). In some embodiments, the shell forms an interphase layer between the core-shell particle's core (e.g., aqueous core) and the major phase (e.g., the hydrophobic solvent). In some embodiments, the composition is a w/o emulsion, wherein the aqueous minor phase forms a core of the core-shell particle, and the interphase forms a shell of the core-shell particle of the invention enclosing and/or stabilizing the aqueous core.

In some embodiments, the inner portion is in contact with the core. In some embodiments, the inner portion is bound to the core. In some embodiments, the shell stabilizes the core. In some embodiments, the shell encapsulates the core.

In some embodiments, the shell is a layered shell. In some embodiments, the inner portion forms a first layer, and the outer portion forms an additional layer. In some embodiments, the inner portion of the shell is mainly composed of the polymeric particles and the outer portion is mainly composed of the hydrophobic metal oxide nanoparticles, or vice versa.

In some embodiments, the shell is or comprises a single layer, wherein the hydrophobic metal oxide nanoparticles and the polymeric particles are mixed therewithin. In some embodiments, the shell defines an intermediate layer (or an interphase) comprising the hydrophobic metal oxide nanoparticles in contact with or bound to the polymeric particles, wherein the intermediate layer is substantially homogenous. In some embodiments, the polymeric particles enhance the stability of the shell, thus prolonging the shelf-life (or stability) of the composition of the invention. In some embodiments, the stable composition of the invention substantially retains the initial particle size of the core-shell particles for a time period described herein, when stored under standard storage conditions (e.g., under ambient conditions at a temperature between 1° and 30° C.).

In some embodiments, the shell has a thickness in the range of 5 nm to 50 nm, 15 nm to 50 nm, 30 nm to 50 nm, 1 nm to 50 nm, 2 nm to 50 nm, 5 μm to 10 nm, 10 nm to 50 nm, 5 nm to 30 nm, 15 nm to 30 nm, 1 nm to 20 nm, 2 nm to 20 nm, 5 nm to 20 nm, or 10 nm to 20 nm, 20 nm to 30 nm, 30 nm to 40 nm, 40 nm to 80 nm, 80 nm to 100 nm, 100 nm to 200 nm, 200 nm to 300 nm, 300 nm to 500 nm, including any range therebetween. In some embodiments, the shell thickness is quantified using scanning electron microscopy (SEM).

In some embodiments, the hydrophobic metal oxide nanoparticles comprise inorganic metal oxide-based particles having a chemical modification (e.g., a hydrophobic group attached thereto). In some embodiments, the inorganic metal oxide-based particles encompass metalloid oxide particles, and a metal oxide particles (e.g. titanium oxide, zirconium oxide, zinc oxide, aluminum oxide, etc.) In some embodiments, the metalloid oxide comprises silica. In some embodiments, the hydrophobic metal oxide nanoparticles are surface modified particles. In some embodiments, the chemical modification is covalently bound to at least a portion of the outer surface of the metal oxide nanoparticle. In some embodiments, at least 10%, at least 20%, at least 30%, at least 40%, at least 50%, at least 60%, at least 70%, at least 90%, at least 95%, at least 99% of the hydroxy and/or oxy groups of the metal oxide nanoparticle are substituted by the chemical modification (e.g., covalently bound to the chemical modification such as a hydrophobic group), including any range between. In some embodiments, at least 10%, at least 20%, at least 30%, at least 40%, at least 50%, at least 60%, at least 70%, at least 90%, at least 95%, at least 99% of the terminal surface —OH and/or —O⁻ groups of the metal oxide nanoparticle are substituted by the chemical modification.

In some embodiments, the hydrophobic metal oxide nanoparticles comprise SiO₂ nanoparticles covalently bound to the chemical modification. In some embodiments, the hydrophobic metal oxide nanoparticles comprise chemically modified SiO₂ nanoparticles. In some embodiments, the chemical modification is covalently bound to at least a portion of the outer surface of the SiO₂ nanoparticle, as described hereinabove.

One skilled in the art will appreciate, that the hydrophobic metal oxide nanoparticles disclosed herein refer to chemically modified particles, wherein the chemical modification comprises any of silylated, halogenated, halogenated and alkylated particle (such as by halo-dimethylsilane) or a haloalkylated particle. In some embodiments, the chemical modification is substantially devoid of fluorine atoms. In some embodiments, the chemical modification comprises a fluorine atom. In some embodiments, the hydrophobic metal oxide nanoparticles disclosed herein are non-fluorinated particles. In some embodiments, the hydrophobic metal oxide nanoparticles disclosed herein, encompass inter alia a metal oxide particle (e.g., silica nanoparticles) modified by silyl, siloxane, polysiloxane, polysilane, (C1-C20)alkyl-silyl, (C1-C20)alkoxysilane, (C1-C20)halosilyl, and/or by (C1-C20)alkyl-halosilyl. In some embodiments, halosilyl, halo, and alkyl-halosilyl contain a halogen selected from Cl, Br, and I.

In some embodiments, the hydrophobic metal oxide nanoparticles comprise polysiloxane-functionalized, polysilane-functionalized, alkyl-functionalized, silane-functionalized, alkoxy silane-functionalized, alkyl silane-functionalized metal oxide nanoparticle, or any combination thereof.

In some embodiments, chemical modification comprises any of polysiloxane, (C1-C20) alkyl, (C1-C20) alkylsilane group, vinyl, epoxy, a cycloalkane, an alkene, an alkyne, an ether, a silyl group, and a siloxane group, or any combination thereof. In some embodiments, the polysiloxane is represented by Formula 1: [—SiR₁R₂—O—]ₙ, or by Formula 1A: R₃—[—SiR₁R₂—O—]ₙ—R₃; wherein: R₁ and R₂ each independently is selected from the group comprising hydrogen, an alkyl group, an alkoxy group, a thioalkoxy group, an aryl group, a fused ring, an alkaryl group, a heteroaryl group, a cycloalkyl group, an aryloxy group, a thioaryloxy group, an ether group, and a halo group or any combination thereof; each R₃ is independently selected from the group comprising: hydrogen, a halo group, an alkoxy group, a hydroxy group, and a bond; and n is an integer ranging from 10 to 150000. In some embodiments, at least one of R1 and R2 is not hydrogen. In some embodiments, the polysiloxane comprises a single polysiloxane specie or a plurality (e.g., 2, 3, 4, or 5) of chemically distinct polysiloxanes.

In some embodiments, n is an integer ranging from 10 to 50, from 50 to 100, from 100 to 120000, 100 to 100000, 100 to 90000, 100 to 70000, 100 to 50000, 100 to 40000, 100 to 30000, 100 to 30000, 100 to 10000, 100 to 9000, 100 to 8000, 100 to 5000, 100 to 4000, 100 to 3000, 100 to 2000, 100 to 200, 200 to 500, 500 to 1000, 200 to 150000, 500 to 150000100 to 150000, 1000 to 150000, 2000 to 150000, 5000 to 150000, 10000 to 150000, 500 to 100000, 500 to 90000, 500 to 70000, 500 to 50000, 500 to 40000, 500 to 30000, 500 to 30000, 500 to 10000, 500 to 9000, 500 to 8000, or 500 to 5000, including any range therebetween.

In some embodiments, R₁, R₂ or both are each independently selected from hydrogen, and a C1-C20 alkyl group. In some embodiments, R₁, and R₂ are each independently C1-C20 alkyl. In some embodiments, C1-20 alkyl comprises between 1 and 20, between 1 and 3, between 3 and 5, between 5 and 10, between 10 and 15, between 15 and 20 carbon atoms (or methylene groups) including any range therebetween. In some embodiments, C1-20 alkyl comprises an alkane, alkene, alkyne, or a combination thereof. In some embodiments, C1-20 alkyl is a liner alkyl. In some embodiments, C1-20 alkyl is a linear alkane.

In some embodiments, R₁, R₂ or both are selected from the group comprising: hydrogen, and a lower alkyl group or both.

As used herein, the term “alkyl” alone or in combination refers to a straight, branched, or cyclic chain containing at least one carbon atom and no double or triple bonds between carbon atoms. As used herein, the term “lower alkyl” refers to a C₁-C₆ alkyl. A “lower alkyl” can be designated as “C₁-C₄ alkyl” or similar designations. By way of example only, “C₁-C₄ alkyl” indicates an alkyl having one, two, three, or four carbon atoms, i.e., the alkyl is selected from among methyl, ethyl, propyl, iso-propyl, n-butyl, iso-butyl, sec-butyl, and t-butyl. Thus C₁-C₄ includes C₁-C₂ and C₁-C₃alkyl. Alkyls can be substituted or unsubstituted. Alkyls include, but are not limited to, methyl, ethyl, propyl, isopropyl, butyl, isobutyl, tertiary butyl, pentyl, hexyl, ethenyl, propenyl, butenyl, cyclopropyl, cyclobutyl, cyclopentyl, and cyclohexyl, each of which are optionally substituted.

In some embodiments, C1-20 alkyl and/or the lower alkyl is substituted by a substituent selected from halo, hydroxy, amino, cyano, nitro, alkylamido, acyl, or a combination thereof.

In some embodiments, R₁, R₂ or both are selected from hydrogen, methyl, ethyl, butyl, isobutyl, or a combination thereof.

In some embodiments, the hydrophobic metal oxide nanoparticles comprise polysiloxane-functionalized silica nanoparticles. In some embodiments, the polysiloxane is or comprises an alkylated siloxane polymer, including any mixture or any copolymer thereof. In some embodiments, the silicon-based polymer comprises poly(dimethyl siloxane) (PDMS) including any mixture or any copolymer thereof. In some embodiments, the polysiloxane comprises PDMS elastomer. In some embodiments, the polysiloxane consists essentially of PDMS.

In some embodiments, the polysiloxane has an average molecular weight ranging from 500 g/mol to 150000 g/mol. In some embodiments, the silicon-based polymer has an average molecular weight ranging from 500 g/mol to 150000 g/mol, from 500 g/mol to 10000 g/mol, from 500 g/mol to 20000 g/mol, 500 g/mol to 50000 g/mol, 500 g/mol to 5000 g/mol, 1700 g/mol to 150000 g/mol, 1900 g/mol to 150000 g/mol, 2000 g/mol to 150000 g/mol, 2500 g/mol to 150000 g/mol, 4000 g/mol to 150000 g/mol, 5000 g/mol to 150000 g/mol, 7000 g/mol to 150000 g/mol, 10000 g/mol to 150000 g/mol, 20000 g/mol to 150000 g/mol, 50000 g/mol to 150000 g/mol, 70000 g/mol to 150000 g/mol, 100000 g/mol to 150000 g/mol, 1500 g/mol to 100000 g/mol, 1500 g/mol to 80000 g/mol, 1500 g/mol to 50000 g/mol, 1500 g/mol to 20000 g/mol, 1500 g/mol to 10000 g/mol, 2000 g/mol to 100000 g/mol, 2000 g/mol to 80000 g/mol, 2000 g/mol to 50000 g/mol, 2000 g/mol to 20000 g/mol, 2000 g/mol to 10000 g/mol, 5000 g/mol to 100000 g/mol, 5000 g/mol to 80000 g/mol, 5000 g/mol to 50000 g/mol, 5000 g/mol to 20000 g/mol, or 5000 g/mol to 10000 g/mol, including any range therebetween.

As used herein throughout, the term “polymer” describes an organic substance composed of a plurality of repeating structural units (backbone units) covalently connected to one another.

In some embodiments, the hydrophobic metal oxide nanoparticles are characterized by an average particle size of 1 nm to 900 nm. In some embodiments, the hydrophobic metal oxide nanoparticles are characterized by an average particle size of 2 nm to 600 nm, 2 nm to 100 nm, 2 nm to 50 nm, 2 nm to 30 nm, 2 nm to 20 nm, 2 nm to 70 nm, 2 nm to 550 nm, 2 nm to 520 nm, 2 nm to 500 nm, 2 nm to 480 nm, 2 nm to 450 nm, 2 nm to 400 nm, 2 nm to 350 nm, 2 nm to 300 nm, 2 nm to 250 nm, 2 nm to 200 nm, 2 nm to 150 nm, 2 nm to 100 nm, 5 nm to 600 nm, 10 nm to 600 nm, 15 nm to 600 nm, 20 nm to 600 nm, 40 nm to 600 nm, 50 nm to 600 nm, 100 nm to 600 nm, 5 nm to 500 nm, 10 nm to 500 nm, 15 nm to 500 nm, 20 nm to 500 nm, 40 nm to 600 nm, 50 nm to 500 nm, 100 nm to 500 nm, 5 nm to 400 nm, 10 nm to 400 nm, 15 nm to 400 nm, 20 nm to 400 nm, 40 nm to 400 nm, 50 nm to 400 nm, 100 nm to 400 nm, 5 nm to 50 nm, 5 nm to 40 nm, 2 nm to 50 nm, or 2 nm to 40 nm, including any range therebetween. In some embodiments, the size of at least 90% of the nanoparticles varies within a range of less than ±25%, ±20%, ±15%, ±19%, ±5% of the above disclosed size, including any value therebetween.

As used herein the terms “average” or “median” size refer to diameter or cross-section of the particles. The average size of the particles can be evaluated using any technique known in the art, e.g., dynamic light scattering (DLS).

Non-limiting example of the hydrophobic particle of the invention is a chemically modified hydrophobic fumed silica, such as AEROSIL® R 202.

The hydrophobic metal oxide nanoparticles can be generally shaped as a sphere, incomplete-sphere, particularly the size attached to the substrate, a rod, a cylinder, a ribbon, a sponge, and any other shape, or can be in a form of a cluster of any of these shapes, or a mixture of one or more shapes. In some embodiments, the hydrophobic particle has a spherical shape, a quasi-spherical shape, a quasi-elliptical sphere, an irregular shape, or any combination thereof.

In some embodiments, the hydrophobic metal oxide nanoparticles are compatible with the polymeric particles. In some embodiments, the hydrophobic metal oxide nanoparticles are dispersible within the hydrophobic solvent described herein. In some embodiments, the hydrophobic metal oxide nanoparticles are configured to stabilize an aqueous core dispersed within the major phase. In some embodiments, the chemical modification (e.g., a polysiloxane, such as PDMS) has an affinity to the polymeric particle. In some embodiments, the hydrophobic metal oxide nanoparticles are capable of binding (e.g., via non-covalent interactions) or adhering to the hydrophobic metal oxide nanoparticles, optionally wherein binding or adhering refers to the ability of the hydrophobic metal oxide nanoparticles to form a homogenous composite with the coalescent polymeric particles or with the polymeric particles in a molten state. In some embodiments, binding or adhering refers to the ability of the hydrophobic metal oxide nanoparticles to undergo non-covalent binding or association with the polymeric particles within the composition of the invention, wherein the hydrophobic metal oxide nanoparticles and the polymeric particles are in a solid state (e.g., below the glass transition point of the hydrophobic metal oxide nanoparticles and of the polymeric particles). In some embodiments, non-covalent binding or association is sufficient to stabilize the liquid core of the core-shell particle of the invention.

In some embodiments, the average particle size (or the average cross-section) of the polymeric particles is between 1 nm and 10 um. In some embodiments, the average particle size (or the average cross-section) of the polymeric particles is between 1 nm and 500 nm, 1 nm and 100 nm, 10 nm and 500 nm, 10 nm and 100 nm, 100 nm and 500 nm, 10 nm and 200 nm, 200 nm and 500 nm, 50 nm and 500 nm, 50 nm and 200 nm, including any range between. In some embodiments, the polymeric particles are polymeric nanoparticles. In some embodiments, the polymeric particles are characterized by a narrow size distribution. In some embodiments, the polymeric particles are characterized by a polydispersity index (PDI), ranging between 0.01 and 0.3, between 0.1 and 0.3, between 0.01 and 0.2, between 0.01 and 0.1, between 0.1 and 0.2, or less than 0.3, less than 0.2, less than 0.1, including any range between.

In some embodiments, the polymeric particles comprise or are essentially composed of a thermoplastic polymer. In some embodiments, the thermoplastic polymer is characterized by a glass transition temperature between 1° and 90° C., between 20 and 90° C., between 2° and 80° C., between 3° and 90° C., between 3° and 80° C., between 3° and 60° C., including any range between.

In some embodiments, the polymeric particles are latex nanoparticles. In some embodiments, the polymeric particles are configured to undergo coalescence at a temperature between 2° and 90° C., between 1° and 200° C., between 2° and 200° C., between 2° and 150° C., between 2° and 100° C., between 2° and 90° C., between 3° and 90° C., between 25 and 90° C., between 2° and 80° C., between 2° and 70° C., between 2° and 60° C., between 3° and 80° C., between 3° and 70° C., between 3° and 60° C., including any range between. In some embodiments, the polymeric particles are configured to undergo coalescence at a temperature above 20° C., above 30° C., above 25° C., above 35° C., above 40° C., and/or below 90° C., including any range between.

The term “coalescence” is well-understood by a skilled artisan and refers inter alia to agglomeration and/or melting or disintegration of the polymeric particles at or above the coalescence temperature thereof, so as to form a polymeric matrix. Thus, during coalescence the polymeric particles merge or agglomerate to form a continuous structure.

In some embodiments, the thermoplastic polymer is or comprises polyacrylate, polyester, polyurethane, polystyrene, including any derivative or any copolymer thereof. Exemplary polyacrylate is PRIMER 1853 (obtained from Michemflex, Belgium).

In some embodiments, the thermoplastic polymer is or comprises polyacrylate. In some embodiments, the thermoplastic polymer is or comprises polyacrylate and polystyrene.

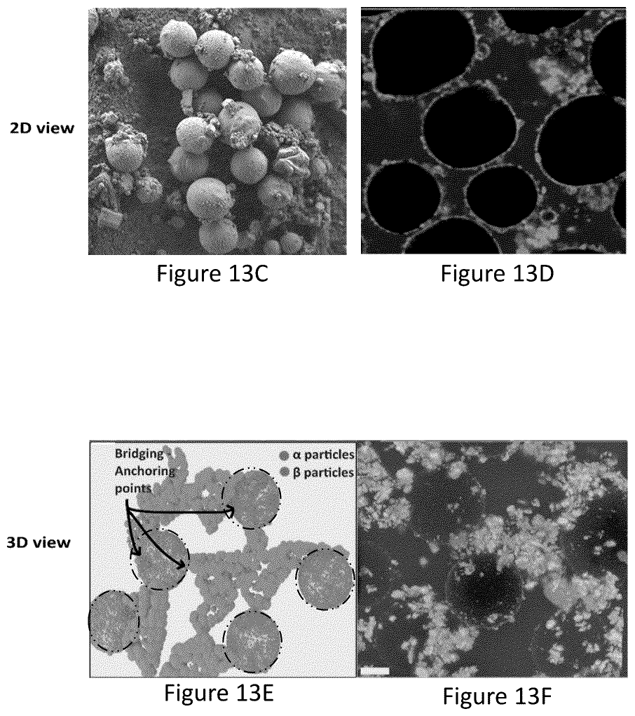

In some embodiments, the polymeric particles stabilize the core-shell particles. In some embodiments, the polymeric particles are in contact with one or more core-shell particles. In some embodiments, contacting is by bridging. In some embodiments, the polymeric particles bridge/connect between two or more core-shell particles. Exemplary bridging is presented in FIG. 13E. In some embodiments, the polymeric particles in contact with the core-shell particles are in a form of a matrix composed of a network of bridges connecting or in contact with two or more core-shell particles. In some embodiments, each bridge is an agglomerate of the polymeric particles.

In some embodiments, the core of the core shell particle of the invention (e.g., droplet) is composed essentially of an aqueous solution.

In some embodiments, the core of the core-shell particle further comprises between 0.1% and 50%, between 0.1% and 5%, between 5% and 10%, between 10% and 20%, between 20% and 30%, between 30% and 50% (w/w) of the active agent including any range therebetween. In some embodiments, the particle core comprises between 0.1% and 50%, between 0.1% and 5%, between 5% and 10%, between 10% and 20%, between 20% and 30%, between 30% and 50% (v/v) of the active agent including any range therebetween.

In some embodiments, the active agent comprises a water-soluble molecule, a lipophilic molecule, a water-insoluble molecule. In some embodiments, the water-soluble molecule has solubility in an aqueous solvent of more than 10 g/L. In some embodiments, the active agent is a bioactive compound. In some embodiments, the active agent comprises an essential oil, an herbicide, a pesticide, a fungicide, or any combination thereof.

As used herein, the term “active agent” refers to any type of material that can be included (solubilized) in the composition of the invention to provide thereto with additional properties which are not present in the absence of the active agent (e.g. anti-microbial activity, plant protecting activity, etc.). In some embodiments, the active agent has anti-fungal, anti-microbial, anti-insect, anti-viral, anti-mold, or plant protective qualities. In some embodiments, the active agent functions as a pesticide. In some embodiments, the active agent comprises a pesticide, an herbicide, a fragrance, a fungicide, or any combination thereof. In some embodiments, the active agent comprises a plurality of active agents, wherein the active agents are as described herein. In some embodiments, the active agent is soluble in the hydrophobic solvent.

In some embodiments, the composition of the invention is a liquid composition comprising a plurality of core-shell particles of the invention dispersed therewithin. In some embodiments, the composition of the invention is in a form of an emulsion (W/O or O/W emulsion), a dispersion, a suspension, and a micro emulsion or any combination thereof. In some embodiments, the composition is in a form of a Pickering emulsion, as described herein. In some embodiments, the composition comprises a water-in-oil (W/O) Pickering emulsion. In some embodiments, the composition comprises an oil-in-water (O/W) Pickering emulsion.

In some embodiments, the composition of the invention is in a form of an emulsion comprising the hydrophobic solvent (e.g., as a major phase) and a plurality of the core-shell particles of the invention dispersed therein. In some embodiments, the composition of the invention is substantially homogenous. In some embodiments, the composition of the invention is in a form of water in oil emulsion, and oil in water Pickering emulsion, comprising the active agent dissolved in the aqueous solution. In some embodiments, the composition of the invention is in a form of water in oil emulsion, and oil in water Pickering emulsion, comprising the active agent dissolved in the hydrophobic solvent.

In some embodiments, a w/w ratio of the hydrophobic solvent to the aqueous solution within the composition is between 6:4 and 10:1, between 6:4 and 8:4, between 2:1 and 3:1, between 3:1 and 5:1, between 5:1 and 10:1, between 2:1 and 10:1, between 2:1 and 5:1, between 6:4 and 3:1, between 3:1 and 10:1, between 3:1 and 8:1, between 6:1 and 10:1, including any range therebetween.

In some embodiments, a w/w ratio between the aqueous solution and the hydrophobic solvent within the composition of the invention is about 1:1 (w/w). In some embodiments, a w/w ratio between the aqueous solution and the hydrophobic solvent within the composition of the invention is between 1:1 and 1:3 (w/w), between 1:1 and 1:2 (w/w), between 1:1.5 and 1:3 (w/w), between 1:1.5 and 1:4 (w/w), between 1:1.5 and 1:5 (w/w), including any range therebetween. In some embodiments, a w/w ratio between the aqueous solution and the hydrophobic solvent within the composition of the invention is about 1:4 (w/w).

In some embodiments, the composition of the invention (e.g., an emulsion) comprises between 30% to 90% (w/w), 30% to 40% (w/w), 40% to 50% (w/w), 50% to 55% (w/w), 55% to 60% (w/w), 60% to 70% (w/w), 70% to 80% (w/w), 80% to 90% (w/w) of the core-shell particles of the invention, including any range therebetween.

In some embodiments, a w/w concentration of the polymeric particles of the invention within the composition of the invention is between 0.5 and 5%, between 1.5 and 5%, between 1.5 and 3%, between 1 and 2%, between 2 and 3%, between 3 and 5%, between 1 and 5%, between 1 and 3%, including any range therebetween.

In some embodiments, a w/w concentration of the hydrophobic metal oxide nanoparticles of the invention within the composition of the invention is between 0.1 and 10%, between 0.1 and 5%, between 0.5 and 5%, between 0.5 and 1%, between 0.5 and 3%, between 1 and 2%, between 2 and 3%, between 3 and 5%, between 1 and 5%, between 1 and 3%, between 1.5 and 5%, between 1.5 and 3%, between 1.5 and 4% including any range therebetween.

In some embodiments, the composition is stable for at least 6 hours (h), at least 12 h, at least 24 h, at least 48 h, at least 72 h, at least 96 h, at least 10 days (d), at least one month (m), at least 3 m, at least 6 m, at least 9 m, at least 12m, at least 24m, up to 3 m, up to 6 m, up to 9 m, up to 24m including any range therebetween.

As used herein the term “stable”, refers to the ability of the liquid composition to maintain substantially its intactness, such as being substantially devoid of aggregation, precipitation and/or phase separation. In some embodiments, a stable composition (e.g., the composition or the liquid composition of the invention) is substantially devoid of aggregates. In some embodiments, aggregates comprising a plurality of cores-shell particles adhered or bound to each other.

In some embodiments, the composition of the invention is stable under normal storage conditions, comprising inter alia any of: (i) a temperature up to 50° C., up to 40° C., up to 30° C., up to 25° C., including any range between; (ii) ambient atmosphere, including exposure to ambient gases and optionally humidity; (iii) pressure about normal atmospheric pressure; (iv) exposure to UV, or any combination of (i) to (iv).

In some embodiments, the liquid composition of the invention comprises an adhesiveness property to a surface of the substrate. In some embodiments, the substrate is as described hereinbelow. In some embodiments, the composition is for use as: a superhydrophobic coating, an oleophobic coating, water-repellent coating, an anti-fungal coating, an anti-microbial coating, an anti-insect coating, an anti-viral coating, an anti-mold coating, an anti-freeze coating, an anti-fog coating, a plant protective coating, food-package coating, or a pesticide coating.

### The Article

According to some embodiments, the present invention provides an article comprising (i) a substrate, and (ii) a coating in contact therewith, wherein the coating comprises hydrophobic metal oxide nanoparticles disclosed herein, and a thermoplastic polymer disclosed herein (e.g., a polyacrylate, a polyester, a polyurethane, including any derivative or any copolymer thereof). In some embodiments, a ratio between the hydrophobic metal oxide nanoparticles and the thermoplastic polymer within the coating is between 30:1 and 1:1, between 20:1 and 5:1, between 25:1 and 5:1, between 30:1 and 10:1, between 20:1 and 10:1, between 30:1 and 5:1, between 4:1 and 1.5:1, between 3:1 and 1.5:1, between 2:1 and 1.5:1, including any range between.

In some embodiments, the coating is as described herein, and is further characterized by (i) a water contact angle of at least 120°, at least 130°, at least 150°, at least 160°, at least 180°, including any range between; and/or (ii) a roll-off angle of between 0 and 10°, between 0 and 5°, between 2 and 10°, between 5 and 10°, between 0 and 7°, between 0 and 9°, between 1 and 10°, between 1 and 5°, including any range between.

In some embodiments, the coating is as described herein and wherein the coating is composed of a plurality of hollow microparticles, wherein a shell of the hollow microparticles comprises the hydrophobic metal oxide nanoparticles and the thermoplastic polymer; and wherein the core of the hollow microparticles is substantially void. In some embodiments, the hollow microparticles are derived from the core-shell particles of the invention. In some embodiments, the hollow microparticles are composed essentially of the coalesced polymeric particles and the hydrophobic metal oxide nanoparticles, wherein the polymeric particles and the hydrophobic metal oxide nanoparticles are as disclosed herein. In some embodiments, the shell of the hollow microparticles is chemically similar or chemically identical with the shell of the core-shell particles described hereinabove. In some embodiments, the hollow microparticles are substantially devoid of polymeric particles disclosed herein.

In some embodiments, the coalesced polymeric particles define apolymeric matrix composed of the thermoplastic polymer, as disclosed herein. In some embodiments, the polymeric matrix is an intertwined matrix composed of randomly distributed polymeric chains of the thermoplastic polymer. In some embodiments, the polymeric chains are randomly distributed within the matrix. In some embodiments, the matrix is substantially devoid of aligned or oriented polymeric chains. In some embodiments, the matrix is substantially devoid of polymeric chains aligned or oriented in a specific direction. In some embodiments, the matrix comprises or is essentially composed of polymeric chains aligned or oriented in a specific direction.

In some embodiments, the hydrophobic metal oxide nanoparticles are embedded within the polymeric matrix. In some embodiments, hydrophobic metal oxide nanoparticles are homogenously distributed within the polymeric matrix. In some embodiments, the hydrophobic metal oxide nanoparticles are enclosed by the polymeric matrix. In some embodiments, the hydrophobic metal oxide nanoparticles are physisorbed and/or chemisorbed on or within the polymeric matrix.

In some embodiments, the hollow microparticles are obtained by drying the composition of the invention applied on the substrate, wherein drying comprises exposing the composition to a temperature suitable for inducing coalescence of the polymeric particles. In some embodiments, the hollow microparticles are derived from the core-shell particles of the invention by exposing thereof to a temperature suitable for inducing coalescence of the polymeric particles (e.g., between 2° and 90° C.).

In some embodiments, the plurality of hollow microparticles are bound to the substrate. In some embodiments, the plurality of hollow microparticles are in a form of a coating layer bound to at least one surface of the substrate. In some embodiments, the plurality of hollow microparticles are impregnated into the substrate. In some embodiments, the plurality of hollow microparticles are embedded into the substrate.

In some embodiments, the coating is in a form of a polymeric matrix consisting essentially of or comprising the thermoplastic polymer, and further comprising the hydrophobic metal oxide nanoparticles embedded or homogenously distributed within the polymeric matrix. In some embodiments, the hydrophobic metal oxide nanoparticles are enclosed by the polymeric matrix. In some embodiments, the hydrophobic metal oxide nanoparticles are physisorbed and/or chemisorbed on or within the polymeric matrix.

In some embodiments, the coating is in a form of hollow microparticles, wherein the neighboring microparticles are in close proximity or in contact with each other, and wherein a shell of the hollow microparticles is composed or consists essentially of the hydrophobic metal oxide nanoparticles and the polymeric particles. In some embodiments, the hydrophobic metal oxide nanoparticles and the polymeric particles are mixed within the shell. In some embodiments, the hydrophobic metal oxide nanoparticles and the polymeric particles are homogenously distributed within the coating.

In some embodiments, each of the hollow microparticles is in a form of a hollow sphere. In some embodiments, between 30% and 99.9%, between 30% and 50%, between 50% and 60%, between 60% and 70%, between 70% and 80%, between 80% and 90%, between 90% and 99.9% by total weight of the hollow microparticles including any range therebetween, is composed of hydrophobic metal oxide nanoparticles and polymeric particles; wherein the core of the hollow microparticle is void (e.g., substantially devoid of a liquid). In some embodiments, the core of the hollow microparticle is substantially devoid of the hydrophobic metal oxide nanoparticles and/or of the polymeric particle, and/or of the thermoplastic polymer.

In some embodiments, the core of the hollow microparticles comprises between 50 and 99.9%, between 50 and 60%, between 60 and 70%, between 70 and 80%, between 80 and 90%, between 90 and 95%, between 95 and 99.9%, v/v of a gaseous material (such as air) including any range therebetween.

In some embodiments, the particle size of the hollow microparticles is comparable with the particle size or diameter of the corresponding core-shell particles described herein. In some embodiments, an average particle size of the hollow microparticles is 0.1% to 10%, 0.2% to 10%, 0.3% to 10%, 0.4% to 10%, 0.5% to 10%, 0.1% to 8%, 0.1% to 5%, or 0.1% to 1%, of the average diameter of the corresponding core-shell particles, including any range therebetween. In some embodiments, an average particle size of the hollow microparticles is 0.5 μm to 100 μm, 0.9 μm to 100 μm, 1 μm to 20 μm, 1 μm to 50 μm, 10 μm to 50 μm, 1 μm to 100 μm, 2 μm to 15 μm, 2.5 μm to 15 μm, 0.5 μm to 10 μm, 0.9 μm to 10 μm, 1 μm to 10 μm, 2 μm to 10 μm, 2.5 μm to 10 μm, 10 μm to 20 μm, 30 μm to 40 μm, 40 μm to 50 μm, 50 μm to 60 μm, 60 μm to 70 μm, 70 μm to 80 μm, 80 μm to 100 μm, including any range therebetween.

In some embodiments, the plurality of hollow microparticles are stably bound to at least one surface of the substrate. In some embodiments, the coating layer is stably adhered to at least one surface of the substrate. In some embodiments, the article and/or the coating layer is stable (e.g., substantially retains bound to the substrate, substantially devoid of physical defects, substantially retains its shape, substantially retains its dimensions, physico-mechanical properties, etc.) upon prolonged storage at least one month (m), at least 6 m, at least 12m, at least 1 year, at least 2 years, including any range therebetween. In some embodiments, the article and/or the coating layer is stable upon exposure to ambient conditions (including inter alia abrasion, weathering conditions, UV radiation, water, water vapors, temperature between −30 and 40° C.).

In some embodiments, the article further comprises an anti-microbial material. In some embodiments, the anti-microbial material comprises wax (e.g., propolis) and/or essential elements (e.g., carvacrol).

According to some embodiments, the present invention provides an article comprising a substrate in contact with a coating comprising the hollow microparticles of the invention, wherein a ratio between the hydrophobic metal oxide nanoparticles and the thermoplastic polymer within the coating is between 30:1 and 1.5:1, between 20:1 and 5:1, between 20:1 and 2:1, between 20:1 and 3:1, between 20:1 and 4:1, between 4:1 and 1.5:1, between 3:1 and 1.5:1, between 2:1 and 1.5:1, including any range between.

According to some embodiments, the present invention provides an article comprising a substrate in contact with a coating comprising the hydrophobic metal oxide nanoparticles embedded or homogenously distributed within the polymeric matrix defined by the thermoplastic polymer, wherein a ratio between the hydrophobic metal oxide nanoparticles and the thermoplastic polymer within the coating is between 30:1 and 1.5:1, between 20:1 and 5:1, between 20:1 and 2:1, between 20:1 and 3:1, between 20:1 and 4:1,between 5:1 and 1.5:1, between 4:1 and 1.5:1, between 3:1 and 1.5:1, between 2:1 and 1.5:1, including any range between.

In some embodiments, the substrate is selected from, a polymeric substrate, glass substrate, a stone substrate, a ceramic substrate, a mineral substrate, a composite substrate comprising stone particles and a polymer, a metallic substrate (including metals such as aluminum, steel, noble metals, transition metals, etc.), a paper substrate, a carton substrate, a polystyrene substrate, a tissue-based substrate, a cellulose-based substrate (e.g. wood, paper, etc.), a brick wall, a sponge, a textile, a non-woven fabric, or wood-substrate, including any combination thereof.

In some embodiments, the substrate is a polymeric substrate comprising a thermoplastic polymer such as a polyolefin (e.g., PE, PP), rubber, a polycarbonate, a polyester, a polyamide, etc. In some embodiments, the substrate is a paper substrate, a metallic substrate, and/or a polymeric substrate. In some embodiments, the substrate is a multi-layered substrate (e.g., a laminate, a coextruded polymeric substrate), etc.

In some embodiments, the coating is in a form of a coating layer. In some embodiments, the coating is in a form of a substantially uniform continuous layer. In some embodiments, the coating layer comprises a residual amount of the hydrophobic solvent (e.g. between 10 ppm and 0.3% by weight of the coating).

In some embodiments, the coating or the coating layer is characterized by an average thickness of 100 nm to 500 μm, 500 nm and 10 um, 500 nm and 50 μm, 1 and 50 μm, 500 nm and 5 μm, 800 nm and 10 um, 800 nm and 5 μm, 100 nm to 400 μm, 100 nm to 300 nm, 300 nm to 500 nm, 500 nm to 1000 nm, 250 nm to 400 μm, 500 nm to 400 μm, 900 nm to 400 μm, 1 μm to 400 μm, 10 μm to 400 μm, 50 μm to 400 μm, 100 μm to 400 μm, 250 μm to 400 μm, 10 nm to 100 μm, 25 nm to 100 μm, 50 nm to 100 μm, 100 nm to 100 μm, 250 nm to 100 μm, 500 nm to 100 μm, 900 nm to 100 μm, 1 μm to 100 μm, 10 μm to 100 μm, 50 μm to 100 μm, 10 nm to 10 μm, 25 nm to 10 μm, 50 nm to 10 μm, 100 nm to 10 μm, 250 nm to 10 μm, 500 nm to 10 μm, 900 nm to 10 μm, or 1 μm to 10 μm, including any range therebetween.

In some embodiments, the coating layer comprises an outer surface facing the ambient and an inner surface facing the substrate. In some embodiments, the outer surface of the coating layer is characterized by a water contact angle (WCA) in the range of between 1200 to 180°, 1300 to 165°, 1300 to 160°, 1300 to 150°, or 1350 to 165°, including any range therebetween.

In some embodiments, the outer surface of the article is characterized by a water contact angle of at least 130°. In some embodiments, the outer surface of the article is characterized by a water contact angle in the range of 1000 to 180°, 1100 to 180°, 120° to 1800, 1300 to 1800, 1300 to 1680, 1300 to 1650, 1300 to 1600, 1300 to 1500, or 1350 to 1650, including any range therebetween.

In some embodiments, the outer surface of the coating layer is characterized by a roll-off (RA) angle of less than 30°, less than 25°, less than 20°, less than 15°, less than 10°, less than 9°, less than 8°, less than 7°, less than 6°, or less than 5°, less than 3° including any value therebetween. In some embodiments, the outer surface of the coating layer is characterized by a RA angle of 100 to 0°, 100 to 3°, 100 to 5°, 9° to 0°, 9° to 3°, 9° to 5°, 8° to 1°, 8° to 3°, 8° to 5°, 5° to 3°, 3° to 0°, 1° to 0°, including any range therebetween. In some embodiments, the outer surface of the article is characterized by an RA angle of less than 10°, less than 9°, less than 8°, less than 7°, less than 6°, or less than 5°, including any value therebetween.

In some embodiments, the outer surface of the coating layer is characterized by a static contact angle of 130° to 170°, 140° to 160°, 135° to 165°, 145° to 155°, 145° to 160°, 150° to 160°, including any range in between.

In some embodiments, the surface roughness of the outer surface of the coating layer is between 20 and 100 nm, between 1 and 10 nm, between 10 and 100 nm, between 10 and 20 nm, between 10 and 50 nm, between 20 and 50 nm, between 50 and 100 nm, between 10 and 200 nm, between 100 and 200 nm, including any range or value therebetween.

In some embodiments, the outer surface of the of the coating layer is characterized by a route mean square of surface height (RMS) of between 20 and 100 nm, between 10 and 20 nm, between 10 and 50 nm, between 20 and 50 nm, between 50 and 100 nm, between 10 and 200 nm, including any range or value therebetween.

In some embodiments, the outer surface of the coating layer is characterized by a peak-to-value-roughness (based on AFM analysis) between 100 and 800 nm, between 200 and 800 nm, between 200 and 600 nm, between 300 and 800 nm, between 300 and 600 nm, including any range or value therebetween.

In some embodiments, the coating layer and/or article is stable at a temperature range of −100° C. to 200° C., −50° C. to 200° C., −10° C. to 200° C., 0° C. to 200° C., 10° C. to 200° C., 50° C. to 1500° C., 100° C. to 200° C., −100° C. to 200° C., −50° C. to 200° C., −10° C. to 200° C., 0° C. to 200° C., 10° C. to 100° C., 100° C. to 200° C., including any range therebetween.

In some embodiments, the coating layer and/or article is characterized by abrasion stability, as determined by the abrasion test, as described hereinbelow.

In some embodiments, the coating layer is characterized by a transparency of 30% to 100%, 40% to 100%, 50% to 100%, 60% to 100%, 70% to 100%, 80% to 100%, 30% to 99.9%, 40% to 99.9%, 50% to 99.9%, 60% to 99.9%, 70% to 99.9%, 80% to 99.9%, 30% to 99%, 40% to 99%, 50% to 99%, 60% to 99%, 70% to 99%, 80% to 99%, 30% to 98%, 40% to 98%, 50% to 98%, 60% to 98%, 70% to 98%, 80% to 98%, 30% to 95%, 40% to 95%, 50% to 95%, 60% to 95%, 70% to 95%, 80% to 95%, 30% to 90%, 40% to 90%, 50% to 90%, 60% to 90%, 70% to 90%, or 80% to 90%, including any range therebetween.

In some embodiments, the article is or comprises a coated cellulose-based substrate, wherein the coated cellulose-based substrate is characterized by a tensile stress of between 50 and 70 MPa, between 50 and 65 MPa, between 55 and 65 MPa, between 55 and 70 MPa, including any range in between.

In some embodiments, the coating layer is water repellent. In some embodiments, the coating layer is water impermeable. In some embodiments, the coating layer substantially reduces water absorption by the substrate.

In some embodiments, the article is characterized by a tensile stress enhanced by at least 2, at least 3, at least 4 times, as compared to a similar article devoid of the coating layer (e.g., uncoated paper).

In some embodiments, the article is or comprises a coated cellulose-based substrate, wherein the cellulose-based substrate and/or the article is characterized by water absorption of up to 40%, up to 30%, up to 25%, or about 20% relative to the dry weight of the article, including any range between. In some embodiments, the article is characterized by at least 2 times, at least 2.5 at least 3 times at least 4 times, at least 5 times reduced water absorption, as compared to a similar article devoid of the coating layer (or as compared to an article comprising the same substrate coated with a latex coating).

In some embodiments, the substrate is a cellulose-based wet substrate, and the article is characterized by at least 2 times, at least 2.5 at least 3 times at least 4 times, at least 5 times greater average maximum tensile stress as compared to a similar article devoid of the coating layer (or as compared to an article comprising the same substrate coated with a latex coating).

In some embodiments, the coating layer is a substantially uniform coating layer, characterized by a substantially uniform density and/or surface pattern. In some embodiments, the coating layer is characterized by a pattern comprising microstructures and nanostructures, and wherein the nanostructures are deposited on top of the microstructures. In some embodiments, the coating layer is characterized by a pattern consisting essentially of microstructures. In some embodiments, the microstructures are in close proximity to each other. In some embodiments, the neighboring microstructures are adjacent to each other. In some embodiments, the neighboring microstructures are in contact with each other (e.g. have at least contact point). In some embodiments, the microstructures are spherically shaped. In some embodiments, the microstructures are elliptically shaped. In some embodiments, the microstructures have a rectangular shape, a rhombical shape, a prism shape, a trapeze shape, a pyramidal shape, a hexagonal shape, a honeycomb shape, or are substantially devoid of a uniform and/or a defined structure. In some embodiments, the microstructures are in a form of a 3-dimensional honey-comb-like structure.

In some embodiments, each microstructure is a hollow shape particle, comprising a hollow (void) core and a shell comprising the hydrophobic metal oxide particles and the polymeric particles disclosed herein. In some embodiments, the hydrophobic metal oxide particles and the polymeric particles are uniformly distributed within the shell. In some embodiments, the hydrophobic metal oxide particles and the polymeric particles are in a form of distinct layers within the shell (e.g. an inner layer facing the core and comprising the metal oxide particles in contact with an outer layer comprising the polymeric particles). In some embodiments, the polymeric particles are in a form of coalesced particles (e.g. coalesced latex particles). In some embodiments, the shell of the microstructures consists essentially of hydrophobic metal oxide nanoparticles and the latex particles, wherein the ratio between the hydrophobic metal oxide nanoparticles and the latex particles is as disclosed hereinabove.

In some embodiments, the nanostructures are in a form of agglomerated nanoparticles, wherein the nanoparticles are characterized by an average particles size of between 10 and 100 nm, between 10 and 80 nm, between 10 and 70 nm, between 10 and 60 nm, between 10 and 50 nm, including any range therebetween.

In some embodiments, the coating layer is an anti-microbial coating.

In some embodiments, the coating layer has at least one characteristic selected from: an anti-fungal coating, an anti-microbial coating, an anti-insect coating, an anti-viral coating, an anti-mold coating, a plant protective coating, and a pesticide coating.

In some embodiments, the coating of the invention is an anti-microbial and an anti-biofilm coating. In some embodiments, the coating of the invention is capable for reducing or preventing at least one of (i) biofilm formation and (ii) microbial load. In some embodiments, reducing is by at least 10%, at least 20%, at least 30%, at least 40%, at least 50%, at least 70%, at least 100%, including any range between compared to a control. In some embodiments, the control is the same substrate being devoid of the coating layer of the invention. In some embodiments, the anti-microbial coating is capable of reducing microbial load by a factor ranging between 2 and 20, between 2 and 5, between 5 and 7, between 7 and 10, between 10 and 12, between 12 and 15, between 15 and 20, including any range between. In some embodiments, the anti-microbial coating is capable of reducing microbial load by a factor ranging between 20 and 100.000, between 20 and 100, between 100 and 1000, between 1000 and 10.000, between 10.000 and 100.000, between 100.000 and 1.000.000, including any range between, as compared to a control (e.g., a similar article devoid of the coating disclosed herein).

In some embodiments, the coating of the invention is an anti-biofilm coating. capable of preventing biofilm formation on top of the coated surface.

As used herein the term “biofilm” refers to any three-dimensional, matrix-encased microbial community displaying multicellular characteristics. Accordingly, as used herein, the term biofilm includes surface-associated biofilms as well as biofilms in suspension, such as flocs and granules. Biofilms may comprise a single microbial species or may be mixed species complexes, and may include bacteria, or other microorganisms.

As used herein, the term “reducing” in any grammatical form thereof, is related to reduction of any type of biofilms (e.g., pellicle, bundle) on or within the article, as compared to a similar article devoid of the coating described herein. In some embodiments, the biofilm formation on the anti-biofilm coating is essentially nullified (e.g., prevented) or is reduced by at least 20%, at least 30%, at least 40%, at least 50%, at least 60%, at least 70%, at least 80%, at least 90%, or by at least 10, at least 100, at least 1000, at least 10000 times, including any value therebetween, as compared to the uncoated substrate.

In some embodiments, the article of the invention comprises a coating layer characterized by reduced microbial load and/or reduced biofilm formation, wherein reduced is by a factor ranging between 2 and 20, between 20 and 100.000, between 20 and 100, between 100 and 1000, between 1000 and 10.000, between 10.000 and 100.000, between 100.000 and 1.000.000, including any range between, as compared to a control. In some embodiments, reduced microbial load refers to a CFU number of the microbe on or within the coating layer, compared to control (e.g., a similar article devoid of the coating disclosed herein). In some embodiments, the microbial load and/or reduced biofilm formation of the control and of the article of the invention are assessed upon exposing thereof to a similar concentration (e.g., CFU) of a microbe.

In some embodiments, the coating layer is characterized by a microbial load of between 1 and 10⁴ CFU per cm², between 1 and 10 CFU per cm², between 10 and 100 CFU per cm², between 100 and 10³ CFU per cm², between 10³ and 10⁴ CFU per cm², between 10³ and 10¹ CFU per cm², including any range between.

In some embodiments, the biofilm comprises bacteria. In some embodiments, the microbe comprises bacteria and/or fungi. In some embodiments, the bacteria are selected from Gram positive bacteria and/or Gram-negative bacteria. In some embodiments, the bacteria are spore forming bacteria. In some embodiments, the bacteria are thermophilic bacteria. In some embodiments, the term “microbe” refers to any prokaryotic organism, including those within all of the phyla in the Kingdom Prokaryote. It is intended that the term “bacteria” encompasses all microorganisms considered to be bacteria including Escherichia, Mycoplasma, Chlamydia, Actinomyces, Streptomyces, and Rickettsia. All forms of bacteria are included within this definition including cocci, bacilli, spirochetes, spheroplasts, protoplasts, etc.

In some embodiments, the bacteria are of the genus Escherichia. In some embodiments, the bacteria is or comprises E. coli.

In some embodiments, the coating layer according to the present invention, is stable to climatic changes. In some embodiments, the coating layer is stable to temperature changes, heat, cold, UV radiation and atmospheric corrosive elements. In some embodiments, the characteristics of the coating layer are not affected or altered by climatic changes as described herein. In some embodiments, the article according to the present invention, is stable to climatic changes. In some embodiments, the article is stable to temperature changes, heat, cold, UV radiation and atmospheric corrosive elements. In some embodiments, the characteristics of the article are not affected or altered by climatic changes as described herein.

### The Method

According to some embodiments, the present invention provides a method of coating a substrate. In some embodiments, the method comprises the steps of: i) providing a substrate; and ii) contacting at least a portion of the substrate with the composition as described herein, thereby forming a coating layer on the substrate. In some embodiments, the method of the invention further comprises providing the coating layer under conditions appropriate for drying of the liquid coating layer, thereby obtaining a dry coating layer on top of the substrate. In some embodiments, the method of the invention is for obtaining a coated substrate, as described herein. In some embodiments, the substrate is as described herein.

In some embodiments, conditions appropriate for drying comprise exposing the coating layer to temperature above the glass transition point of the polymeric particles (and/or of the thermoplastic polymer), as described herein. In some embodiments, conditions appropriate for drying comprise exposing the coating layer to temperature above the coalescence point of the latex polymeric particles. In some embodiments, conditions appropriate for drying comprise exposing the coating layer to temperature between 1° and 200° C., between 2° and 200° C., between 4° and 200° C., between 5° and 200° C., between 4° and 100° C., between 4° and 150° C., between 2° and 80° C., between 25 and 80° C., between 3° and 90° C., between 3° and 80° C., between 3° and 60° C., including any range between. In some embodiments, the temperature is below melting temperature or disintegration temperature of the substrate.

In some embodiments, drying comprises exposing the coating layer to any one of vacuum, thermal irradiation, microwave irradiation, infra-red irradiation, and UV-visible irradiation, or any combination thereof.

In some embodiments, contacting is selected from the group comprising: spin coating, roll coating, spray coating, and kiss coating, air knife coating, anilox coater, flexo coater, gap coating, dip coating, rod coating, and dipping.

In some embodiments, drying is by providing a coated substrate are placed in a hot air oven thereby obtaining dry coated substrate, wherein the oven is at a temperature ranging from 20° C. to 180° C., 25° C. to 180° C., 30° C. to 180° C., 30° C. to 150° C., 30° C. to 90° C., 30° C. to 80° C., 30° C. to 70° C., 30° C. to 60° C., 40° C. to 180° C., 40° C. to 150° C., 40° C. to 90° C., 40° C. to 80° C., 40° C. to 70° C., 40° C. to 60° C., 50° C. to 180° C., 50° C. to 150° C., 50° C. to 90° C., 50° C. to 80° C., 50° C. to 70° C., or 50° C. to 60° C., including any range therebetween.

In some embodiments, the drying is performed for a period of time in the rage of 1 hour to 24 hour, 2 hour to 24 hour, 3 hour to 24 hour, 5 hour to 24 hour, 6 hour to 24 hour, 1 hour to 12 hour, 2 hour to 12 hour, 3 hour to 12 hour, 5 hour to 12 hour, 6 hour to 12 hour, 1 hour to 8 hour, 2 hour to 8 hour, 3 hour to 8 hour, or 5 hour to 8 hour, including any range therebetween.

In some embodiments, drying comprises air drying.

In some embodiments, the coating adheres to the substrate. In some embodiments, the article is stable. In some embodiments, the article is stable upon exposure to UV radiation, IR radiation, visible light radiation, thermal radiation microwave radiation or any combination thereof.

As used herein the term “stable” refers to the capability of the article (e.g., a coated substrate) to maintain its structural and/or mechanical integrity such as being devoid of cracks and/or deformations. In some embodiments, the article is referred to as stable, if the article substantially maintains its structural and/or mechanical integrity under outdoor conditions such as a temperature −25 and 75° C., UV and/or visible light irradiation. In some embodiments, the stable article is rigid under outdoor conditions. In some embodiments, the stable article maintains its tensile strength and/or elasticity. In some embodiments, substantially is as described hereinbelow. In some embodiments, the stable article is capable to maintain its superhydrophobic properties (e.g. to substantially maintain its initial water contact angle) upon successive abrasion cycles, as disclosed herein.

In some embodiments, the article is in a form of a film. In some embodiments, the article is in a form of a continuous layer. In some embodiments, the article is in a form of a dishware. In some embodiments, the article is in a form of a packaging material. In some embodiments, the article is in a form of a packaging article. In some embodiments, the article is in a form of a food packaging article. In some embodiments, the packaging material is for packaging an edible matter.

In some embodiments, the coated substrate has at least one characteristic selected from: an anti-fungal coating, an anti-microbial coating, an anti-insect coating, an anti-viral coating, an anti-mold coating, a plant protective coating, a pesticide coating.

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method, or structure (e.g. coating) may include additional ingredients, steps and/or parts, but only if the additional ingredients, steps and/or parts do not materially alter the basic and novel characteristics of the claimed composition, method, or structure. Thus, the term “consisting essentially of”, as used herein means that the composition, method, or structure (e.g. coating) is substantially devoid of any active ingredient other than the constituents of the composition disclosed herein.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “substantially” refers to at least 85%, at least 90%, at least 92%, at least 95%, at least 96%, at least 97%, at least 98%, at least 99% including any range or value therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical, and medical arts.

As used herein, the term “treating” includes abrogating, substantially inhibiting, slowing, or reversing the progression of a condition, substantially ameliorating clinical or aesthetical symptoms of a condition, or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments unless the embodiment is inoperative without those elements.

Various embodiments and aspects of the present invention as delineated hereinabove and as claimed in the claims section below find experimental support in the following examples.

### EXAMPLES

### Materials and Methods

### Preparation of the Silica Stabilized Pickering Emulsions

Pickering emulsions were prepared based on hydrophobic silica (Aerosil R202, with an estimated primary particle size of 14 nm, obtained from Evonik, Germany) in latex PRIMER 1853.E (obtained from Michemflex, Belgium) aqueous solution in double distilled water (DDW) (1 wt % %) and solvent (toluene, dimethyl carbonate or cyclohexane) (analytical grade obtained from Fisher Scientific, UK). The hydrophobic silica NPs were dispersed in v/v % ml of toluene or dimethyl carbonate with a wide range of v/v % ratios of latex solution by ultrasonication for 10 min (Sonics Vibra-Cell 750 W, 25% amplitude) with a silica content of different wt %.

### Preparation of Latex Stabilized Pickering Emulsions in DMC

Pickering emulsions were prepared in DMC with latex (Latex PRIMER 1853) dispersed in water (1 wt %) in different oil:water ratios. The miscibility of DMC in water is 13.9% therefore, the solvent volume was calculated based on the following equation: oil ml x 1.139=solvent ml (e.g., for a 8:2 oil:water ratio the solvent required is 8 ml X 1.139=9.112 ml). The overall methodology was as follows: organic solvent and latex aqueous dispersion (1 wt %) were sonicated for 10 minutes to obtain a final emulsion volume of 10 ml.

### Preparation of Silica and Latex Stabilized Pickering Emulsions in DMC

Pickering emulsions were prepared using hydrophobic silica (Aerosil R202, with an estimated primary particle size of 14 nm, obtained from Evonik, Germany) in different mass fractions wt % along with latex aqueous dispersion(1 wt % %) and DMC. As disclosed above, the solvent volume was calculated using the following equation oil ml×1.139=solvent ml. The Pickering emulsions has been prepared by dispersing various v/v % of hydrophobic silica NPs in dimethyl carbonate along with an aqueous latex dispersion. In brief, the entire constituents were mixed together and treated by ultra-sonication for 10 min in a 10 ml glass vial.

### Coatings Application

As prepared, the emulsions were applied on different surfaces via the roll coating (wire length 45 cm, wire diameter 1 mm) method. In order to enable rapid evaporation of the emulsions, the surfaces were placed in a hot air oven maintained at 60-80° C. for 1 hour.

### Instability Analysis

Instability analysis of the emulsions was performed using the multisampling analytical centrifuge LUMiSizer® (L.U.M. GmbH, Berlin, Germany), which allows the measurement of the intensity of the transmitted light as a function of time and position over the entire sample length simultaneously.

### Microscopy and Image Analysis

### Confocal Microscopy

The samples were analyzed by laser scanning confocal microscopy (Leica, Wetzlar, Germany) using 552 nm excitation light. Fluorescence emission of Nile red was recorded at 565-660 nm. The average droplet diameter was measured for every sample by the Fiji software particle analysis tool based on confocal microscopy images.

The silica and/or latex stabilized Pickering emulsions in DMC were examined by labelling the oil, the silica and the latex with Nile Red 5, 6-carboxy-fluoreceine and Nile blue respectively. Imaging was performed via a confocal fluorescent microscope using a solid-state laser with 552, 493 and 631 nm for excitation of Nile red 5, 6 Carboxy-fluorescein and Nile blue, respectively. Fluorescent emission of each dye was detected at a dye-specific wavelength of 635, 517 and 660 nm, respectively. For analysis, 2 μl were drop-casted on a glass slide and covered using a coverslip. Droplet size distribution was analyzed using Fiji software by measuring the droplet diameters (not less than 100 droplets in two images).

### Cryogenic-Scanning Electron Microscopy (Cry-SEM)

Cryogenic-scanning electron microscopy analysis performed on a JSM-7800F Schottky field-emission SEM microscope (Jeol Ltd., Tokyo/Japan), equipped with a cryogenic system (Quorum PP3010, Quorum Technologies Ltd., Laughton/United Kingdom). Liquid nitrogen was used in all heat exchange units of the cryogenic system. A small droplet of an emulsion was placed on the sample holder, between two rivets, quickly froze in liquid nitrogen for a few seconds, and transferred to the preparation chamber where it was fractured (at −140° C.). The revealed fractured surface was sublimed at (−85° C. for 20 min) to eliminate any presence of condensed ice and then was coated with platinum (10 mA for 50 seconds). The temperature of the sample was kept at −140° C. Images were acquired with a low electron detector (LED) at an accelerating voltage of 5.0 kV and a working distance of (4 mm).

### Abrasion Resistance Analysis

Abrasion resistance of coatings was done using standard nitrile gloves. Coated samples were placed on a scale and pressed using a finger. The finger was moved across each sample in a single direction while maintaining 1 kg pressure. Each full finger swipe across the sample was counted as a single abrasion cycle.

### Water Absorption Tests

For the test, 5 papers samples of each group (i.e., Control, Latex and Super hydrophobic coating -SHC) were cut into 3×1 inch. Each sample was then fully immersed for 10 seconds and dried on dry paper (Kim-wipe) for 2 seconds and measured on analytical scales for its weight. For the confocal characterization, 6-amino fluorescein (1 mg/L) were added to the water in which samples were immersed in.

### Mechanical Analysis

Mechanical properties of uncoated and coated paper samples were performed using extensometer (Instron 3345). The measurements were performed according to a standard measuring method (ASTM D828), using a 5,000 N testing head, 9 and 4 bar of clamp pressure while testing dry and wet samples respectively. During wet sample measurements, samples were immersed in DDW for 5 seconds and then hung dry for 45 seconds before measuring occurred.

### Solvent Residuals

Detection of DMC residues in dry samples was done using (GC/MS). The test was performed on paper samples which were cut into small squares (˜several mm sized samples), and subsequently weighed. The residual DMC content of the samples was normalized against the weight of each sample. DMC concentrations were determined according to a previously prepared calibration curve between 0.5-20 ppm.

### Biofilm Assay

Mueller Hinton (MH) growth medium was inoculated with bacteria and diluted until suspension reached OD595 (3×10⁸ CFU). Then, the diluted medium was aliquoted into a 24-well plate (SPL Life Sciences). In order to assess the anti-bacterial/biofilm activity of the coatings, 1×1 cm cutouts or 2×2 cm of the coated PP were placed face down into the previously made Mueller Hinton (MH) growth medium. Then, samples were incubated for 20 hours at 37° C. and rinsed three times in order to remove planktonic cells. Gathering of multicellular cells from the surface was done by using 250 μL of MH 1% by a cell scraper (Greiner Bio-one). Each sample was then diluted using MH 1% for a final volume of 2 ml. After dilution, samples were bath sonicated (20 minutes, 37 kHz) and mixed for another 30 minutes using vortex. After mixing, a serial dilution was done, using 180 μl of each sample in order to reach the final dilution. Bacteria were then spotted into a lysogeny Broth (LB) agar plates and incubated for 20 hours at 37° C. The growth of bacteria was determined by counting the viable cells.

### Surface Wetting Analysis

To study the surface wettability, static water contact angles (CAs) and roll off angles (RAs) were measured at ambient temperature using a drop shape analyzer (DSA 100 Kruss). 5 μl water (AR Grade) droplets dispersed on the coating surfaces and side view images were captured. To measure the water RAs, the stage was tilted followed by a deposition of 5 μl of water droplets onto the surface. RAs were recorded as the stage tilt angle at which all the water droplets started to roll away from the coating surface. To confirm the reproducibility of the results, eighteen measurements were checked on two duplicate samples that fabricated under identical conditions.

The surface wettability, static water contact angle (CA) values of silica and latex stabilized Pickering emulsions in DMC were measured by drop shape analyzer. In brief, 200 ml of water (AR Grade) were heated using a hotplate or cooled using an ice bath, then 5 μl drops of the Pickering emulsion were taken using a pipette and manually deposited onto the surface. Similarly, for the dynamic contact angle measurements, 5 μl water (AR Grade) were deposited onto the surface using a loop activity of deposition and suction, then images were captured and analyzed using “Advance” software. To confirm the reproducibility of the results, nine measurements of two duplicate samples were performed.

### Morphological Study

The microstructure of the polymer particles prepared was examined using Transmission Electron Microscopy (TEM). To perform the Cryo-TEM analysis the latex was diluted with double distilled water. A drop of diluted latex was placed on a carbon coated grid and dried in a dissector.

### Scanning Electron Microscope (SEM)

Scanning Electron Microscope (SEM) images of fabricated coatings was obtained using model MIRA3 from TESCAN at 5 KV and a secondary electron detector. In order to prepare samples for SEM analysis, the Pickering emulsion coated PP surface was deposited onto an aluminum sample holder covered with carbon tape. The samples were sputter-coated with gold palladium to reduce charging effects. The atomic force microscope (AFM) analyses were performed with a commercial AFM (JPK Nanowizard III), operated in the tapping mode. Silicon cantilevers coated with aluminum were used at a spring constant of ˜40 N/m and were driven at a frequency of 250 KHz in air. All the AFM experiments were carried out at room temperature.

### Atomic Force Microscope (AFM)

The atomic force microscope (AFM) analyses were performed with a commercial AFM (JPK Nanowizard III), operated in the tapping mode. Silicon cantilevers coated with aluminum were used at a spring constant of ˜40 N/m and were driven at a frequency of 250 KHz in air. All the AFM experiments were carried out at room temperature.

### Example 1

### Preparation of Latex Based Emulsion

The inventors performed various tests using DMC as the hydrophobic solvent and an aqueous latex dispersion to test the ability of emulsion formation at varying solvent ratios with or without hydrophobic silica nanoparticles. The oil-water ratio was varied accordingly (to obtain a final volume of 10 mL). The overall methodology was as follows: a mixture of DMC and aqueous latex dispersion (1 wt % of the latex particles) was sonicated for 10 minutes. The results are summarized in Table 1.

TABLE 1
Latex based DMC:Water system at different solvents
ratios of either 2:8, 3:7, 4:6 or 5:5, 8:2, 7:3.

| Day | DMC:water | 2:8 | 3:7 | 4:6 | 5:5 | 8:2 | 7:3 |
|---|---|---|---|---|---|---|---|
| Day 0 | Emulsion | + | + | + | + | + | + |
| | formation | | | | | | |
| | Characteristic | o/w | o/w | o/w | o/w | o/w | o/w |
| | Droplet number | 200 | 100 | 200 | 200 | 120 | 28 |
| | Mean | 8.88 | 11.85 | 7.19 | 13.63 | 9.13 | 39.97 |
| | diameter[micron] | | | | | | |
| | Standard | 200 | 100 | 200 | 200 | 120 | 28 |
| | deviation [%] | | | | | | |

A high standard deviation value in ratio 2:8, 4:6, 5:5, 7:3 and 8:2 indicated a polydispersed system where droplets in various diameters were observed in the same emulsion.

DMC-based emulsions prepared with 1% wt total polymer concentration and varying oil: water ratios of 2:8, 3:7, 4:6, 5:5, 7:3, and 8:2 at a constant total polymer concentration of 1% wt were evaluated for droplet size distribution studies using confocal microscopy. The size distribution and mean diameter of oil droplets in these emulsions are shown in Table 1. As seen from Table 1, the oil phase concentration variation affected the size distribution profile of oil droplets with the average droplet diameter ranging from 8.88 to 39.97 μm. The average diameter plotted as a function of oil: water ratios suggests that the increase in the solvent proportion (and the consequent decrease in the water proportion) led to an increase in the average diameter of droplets (Table 1).

For the microstructure understanding, emulsion samples were freeze-fractured, and the water was sublimated in the cryo-preparation chamber before imaging the samples under a cryogenic electron microscope.

The sublimation of water in the fractured sample made it possible to see the presence of a pore-like reticular network of polymers in the inner space and the continuous water phase confirming that the emulsion samples had a complex microstructure.

Looking closely at CryoSEM images of oil-in-water toluene and water (8:2) based emulsion with latex polymer 1 wt % %, the inventors saw individual spheres with one thin and distinct layer. Once latex particles fully covered the droplet surface, the polymer shell was formed by sintering the latex particle into one homogenous monolayer. It was achieved by heating the emulsion to above the Tg (or coalescence point) of the acrylic latex particles (˜25° C.) to induce particle coalescence.

Emulsions prepared with DMC and latex copolymer in the water phase were O/W types for the time zero and showed instant flocculation and creaming. The cryo-SEM images of freeze-fractured sample of the creamed layers suggests that the oil droplets are surrounded in mesh of polymer network providing a barrier, preventing any internal contacts among the oil droplets. On the fifth day, the inventors observed changes in the behavior of the emulsions. Confocal microscopy showed complete phase separation and droplets absence for ratios 2:8, 4:6, 6:4—so called transition step in phase inversion. For the ratios of 6:4, 7:3, 8:2, a phase inversion occurred towards the water: oil emulsion (Table 2). Thus, it was clear that no stable emulsion can be formed solely based on latex as the emulsion stabilizer.

In Pickering emulsions, the emulsion type is controlled by the wettability of silica nanoparticles. Consequently, phase inversion can be triggered by varying the hydrophobicity of the emulsifiers or other physical or chemical parameters such as pH, electrolytes, temperature, surfactant concentration, etc. In this case, transitional phase inversion from an O/W emulsion to a W/O emulsion occurred due to competition between silica nanoparticles dispersed in oil part and surfactant in the water part of 1 wt % latex solution. Transitional phase inversion can be achieved by altering the Hydrophilic-Lipophilic balance (HLB) of any emulsion system at a fixed volume fraction of the dispersed phase. The inversion from o/w to w/o emulsion can be achieved by decreasing the HLB of the system and reverse. Accordingly, the inventors postulated that in order to obtain a stable emulsion, there is a need to incorporate hydrophobic silica nanoparticles within the emulsion.

### Preparation of Latex-Hydrophobic Silica-Based Pickering Emulsion

Trials and tests conducted in the DMC: latex dispersed in water with hydrophobic silica experiment are summarised in Table 2, for time zero, day 5, and day 32. This stage was to test the ability of emulsion formation with various components and the ratio of solvent with silica nanoparticles. The oil-water ratio was varied accordingly (to obtain a final volume of 10 mL) along with the silica (1 wt. %) concentration. The DMC solvent, R202 silica, and acrylic latex copolymer dispersed in water were used. The overall methodology was as follows; dispersed silica particles in the organic solvent- DMC and latex-based water were sonicated for 10 minutes to obtain a 10 mL mixture.

TABLE 2
Trial phase; DMC:water Latex with hydrophobic silica 1 wt % system at different
solvents ratios of either 2:8, 3:7, 4:6 and 5:5, 6:4, 7:3, 8:2.

| Day | DMC:water | 2:8 | 3:7 | 4:6 | 5:5 | 8:2 | 7:3 | 6:4 |
|---|---|---|---|---|---|---|---|---|
| Day 0 | Emulsion | + | + | + | + | + | + | |
| | formation | | | | | | | |
| | Characteristic | o/w | o/w | o/w | w/o | o/w | o/w | Transitional |
| | Droplet number | 60 | 100 | 80 | 100 | 34 | 15 | 60 |
| | Mean | 5.73 | 6.22 | 5.57 | 4.99 | 11.32 | 16.56 | 5.73 |
| | diameter[micron] | | | | | | | |
| Day 5 | Emulsion | − | + | − | + | + | + | |
| | formation | | | | | | | |
| | Characteristic | | o/w | | w/o | o/w | w/o | Transitional |
| | | | | | | | | to w/o |
| | Droplet number | | 100 | | 100 | 25 | 100 | |
| | Mean | | 3.77 | | 6.83 | 5.35 | 4.73 | |
| | diameter[micron] | | | | | | | |
| Day | Emulsion | − | − | − | + | + | + | + |
| 32 | formation | | | | | | | |
| | Characteristic | | | | w/o | w/o | w/o | w/o |
| | Droplet number | | | | 100 | 100 | 100 | 100 |
| | Mean | | | | 4.29 | 5.49 | 3.61 | 3.20 |
| | diameter[micron] | | | | | | | |

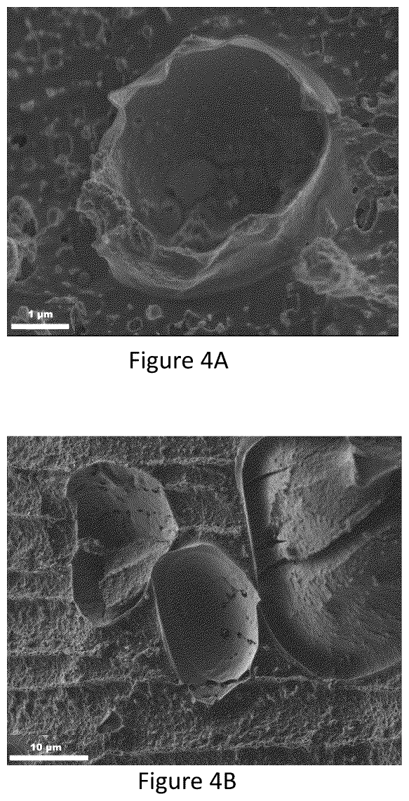

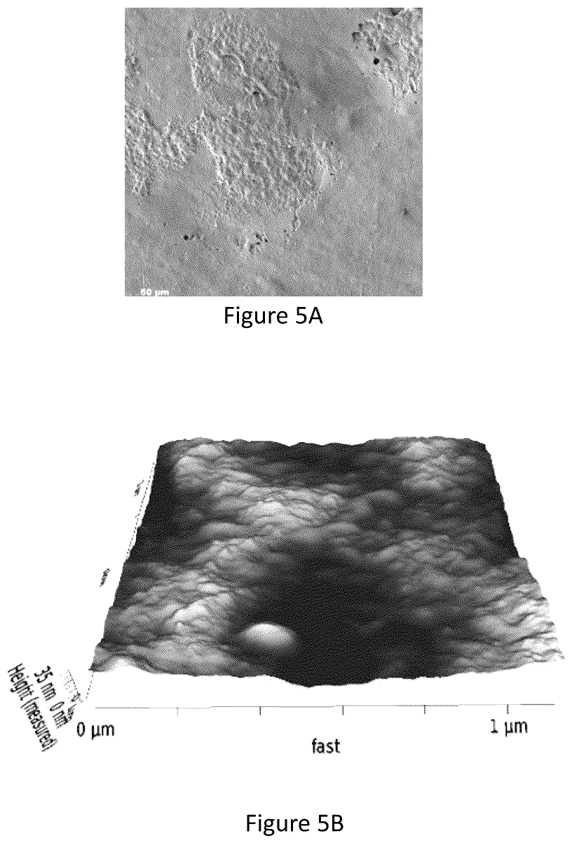

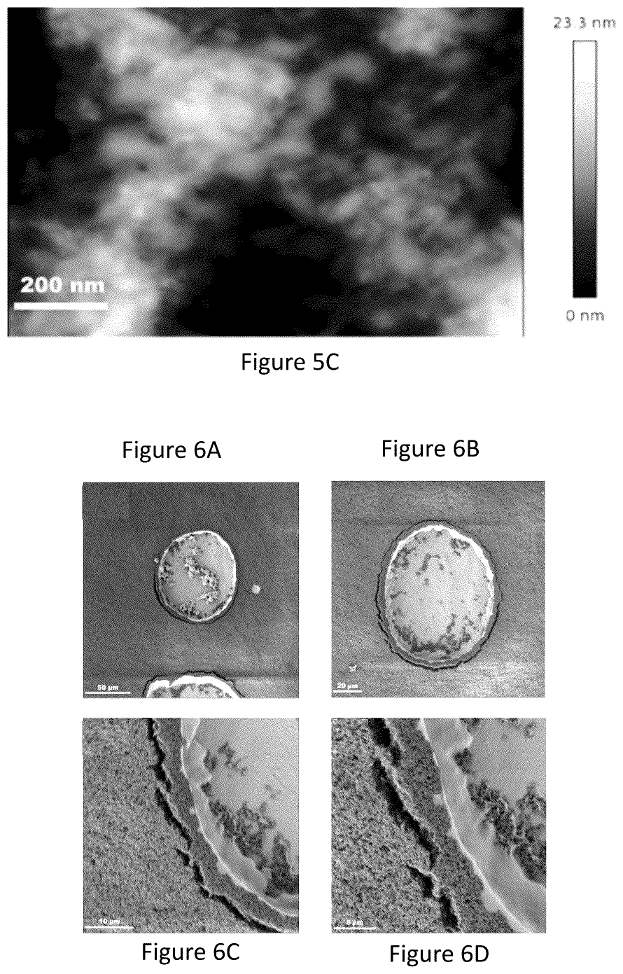

After heating the treated polypropylene surface to 60° C. for 1 h, the inventors could distinguish individual droplets via cryo-SEM, which suggested that heating doesn't induce fusion of the neighboring droplets (FIG. 4A).

TABLE 3
Trial phase; DMC:water 1wt % Latex- hydrophobic silica 2 wt % system at
different solvents ratios of either 2:8, 3:7, 4:6 and 5:5, 6:4, 7:3, 8:2.

| Day | DMC:water | 2:8 | 3:7 | 4:6 | 5:5 | 8:2 | 7:3 | 6:4 |
|---|---|---|---|---|---|---|---|---|
| Day 0 | Emulsion | + | + | + | + | | + | + |
| | formation | | | | | | | |
| | Characteristic | w/o | w/o | w/o | o/w | Transitional | o/w | o/w |
| | Droplet | 50 | 100 | 100 | 100 | | 100 | 100 |
| | number | | | | | | | |
| | Mean | 4.99 | 3.18 | 3.58 | 4.26 | | 7.82 | 10.47 |
| | diameter[micron] | | | | | | | |
| | Standard | 2.16 | 1.79 | 2.20 | 2.57 | | 13.31 | 17.73 |
| | deviation | | | | | | | |
| Day 5 | Emulsion | + | + | + | + | Transitional | Transitional | Transitional |
| | formation | | | | | | | |
| | Characteristic | wlo | w/o | w/o | w/o | | | |
| | Droplet | 50 | 100 | 100 | 100 | | | |
| | number | | | | | | | |
| | Mean | 5.43 | 5.88 | 5.75 | 5.23 | | | |
| | diameter[micron] | | | | | | | |
| | Standard | 2.37 | 4.43 | 3.48 | 3.65 | | | |
| | deviation | | | | | | | |

In the additional experiments, the inventors observed that stable compositions of the invention (emulsions) can be formed using 2% wt hydrophobic silica NP (Aerosil R202, a PDMS functionalized silica NP) at various DMC:water (1% wt % Latex NPs) ratios ranging between 9:1 and 2:8, respectively. The inventors currently postulate that the most preferable DMC:water v/v range is at least 1:1, or between 6:4 and 9:1, such as between about 8:2 and 9:1.

The coating obtained by deposition of an exemplary composition of the invention containing DMC: water at 8:2 volume ratio, 1% wt % Latex and 2% wt hydrophobic silica (also referred to herein as “super-hydrophobic coating”), was characterized by Cryo-SEM and Confocal microscopy. Carboxy-fluorescein was covalently bonded to hydrophobic silica. The addition of hydrophobic silica formed a reverse emulsion of water in oil (DMC). Micrographs of a single droplet (FIG. 13A, FIG. 13B), show small latex aggregates attached to a continuous interface shell layer (primarily comprised of hydrophobic silica). A similar structure was observed when several droplets were examined as well (FIG. 13D).

To understand the spatial arrangement of the studied system confocal images were gathered and stacked (Z-stack) to form a single 3D image of ˜15 μm. The stacked image (FIG. 13F) shows that silica particles are the primary stabilizer and remain at the interface. The acrylic latex particles assist in stabilizing water droplets and occupy the interface as co-stabilizers, but more predominantly, form a stable particle network between water droplets at the major phase. Without being limited to any specific theory, it has been postulated that each particle type fulfills a different role in the formation and stabilization of the emulsion, therefore, the terms “a particle” and “β particle” were assigned to the silica and the acrylic latex particles, respectively (FIG. 13C). Interestingly, once the silica particles were added, the location and arrangement of the latex particles changed from being dispersed in water, to forming bridging structures in the major phase. The schematic representation (FIG. 13E) demonstrates the location of each particle type.

### Example 2

The inventors further successfully applied the above-mentioned Pickering emulsions on top of substrate samples (e.g. glass, paper, aluminum, and polypropylene). The surface morphology, water repellence and mechanical properties of the resulting coated substrates have been extensively examined.

### Coated Surfaces Analysis

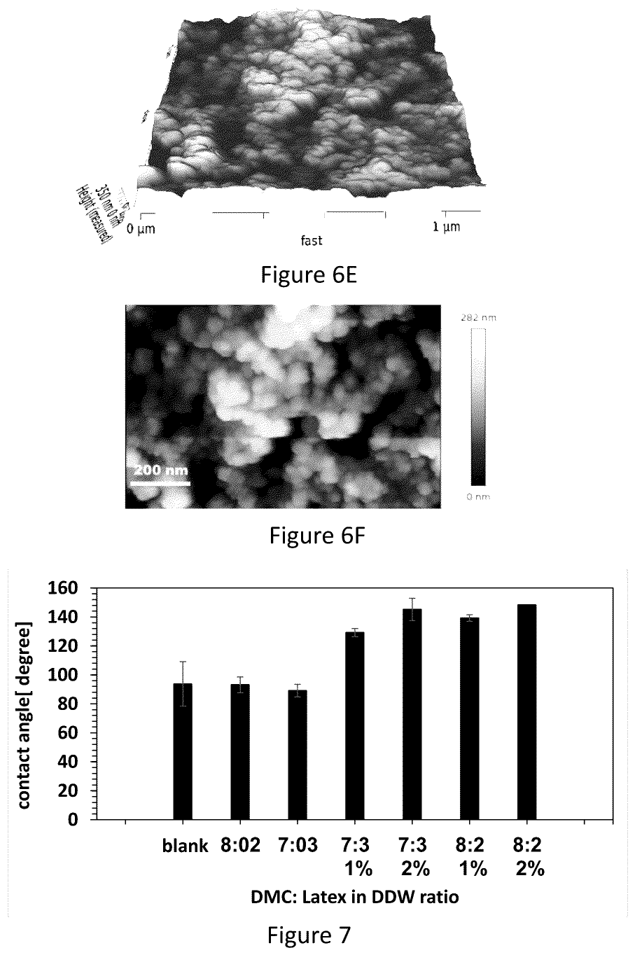

This study shows AFM measurements made on four different interfaces. First, an untreated polypropylene surface was used as a comparison blank. Also, as a comparative analysis, polypropylene surfaces coated with 1% latex emulsion, and emulsions not containing stabilizing nanoparticles were investigated. The blank sample surfaces (FIG. 6A) were relatively flat, with an average roughness (Rₐ) between 5.22±0.44 to 6.68±0.57. Meanwhile, the Rₐ of the proper coating is 51.46±1.58. Surface wettability was investigated by CA. Measurement results of these coatings are shown in FIG. 7.

The composite coatings of the untreated polypropylene surface and covered by non-silica emulsions showed similar CA values and were less than 90° (FIG. 7). Silica content affected the wettability of coatings. With an increase in the concentration of nanoparticles, the contact angle rose to 150°. A low value of the standard deviation indicates the homogeneity and uniformity of the coating.

From these measurements and observations, the inventors concluded that an outstanding superhydrophobic coating could be fabricated based on DMC and 1 wt % latex-based emulsion in ratio 8:2 with 2 wt % silica contents.

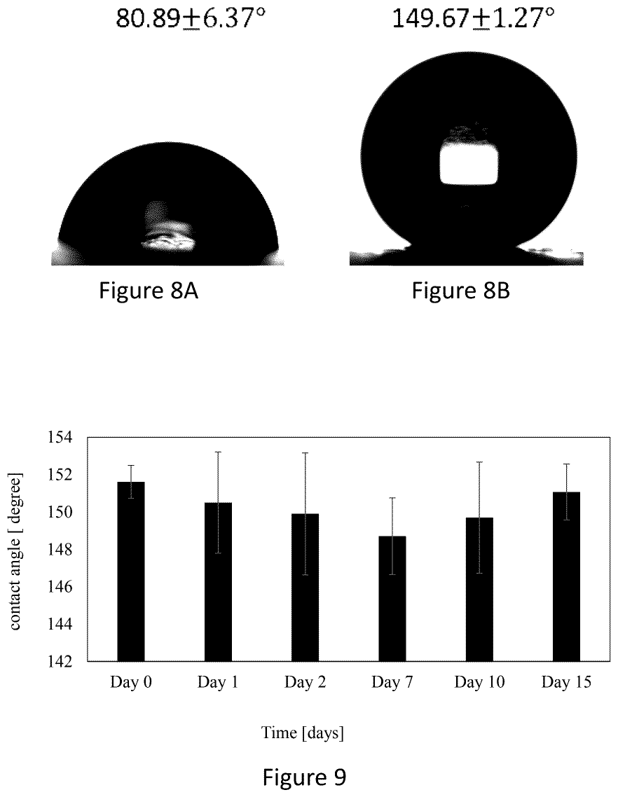

Average static contact angle for coated polypropylene surface found to be 149.67±1.27° and that of untreated surface was found to be 80.89±6.37. FIG. 8 shows the representational images corresponding to water contact angles for coating (FIGS. 8A-B). According to static water contact angles, coating presented in FIG. 8B is significantly increased, compared to the coating presented in FIG. 8A.

To determine the durability of the coating, the treated 4×4 cm polypropylene surface by DMC and latex-based emulsion in ratio 8:2 with 2 wt % silica nanoparticles were immersed in water for half a month being in the same physical and chemical conditions. Changes in the hydrophobic properties of the coating were studied using the contact angle by a mean of 15 measurements (FIG. 9).

On the first day, the contact angle was 151.61, while on the 15th day, this value was 151.07. However, it should be noted that the standard deviation from the mean value became slightly higher, which may indicate a different strength of hydrophobicity at various measured points of the polypropylene surface.

Furthermore, the inventors successfully coated a paper substrate by the exemplary emulsion of the invention, so as to result in a superhydrophobic surface. Whatman paper specimens were coated by one layer emulsion formulations in 9:1 and 8:2 DMC and water ratio stabilized by 1 wt % and 2 wt % silica NPs. For ratio 9:1 with 1 wt % silica NPs the value of contact angle was 126.48°, while for 2 wt %, the contact angle was 141.45°. For 8:2 ratio with 1 wt % the contact angle was 143.00° and with 2 wt % 149.72°.

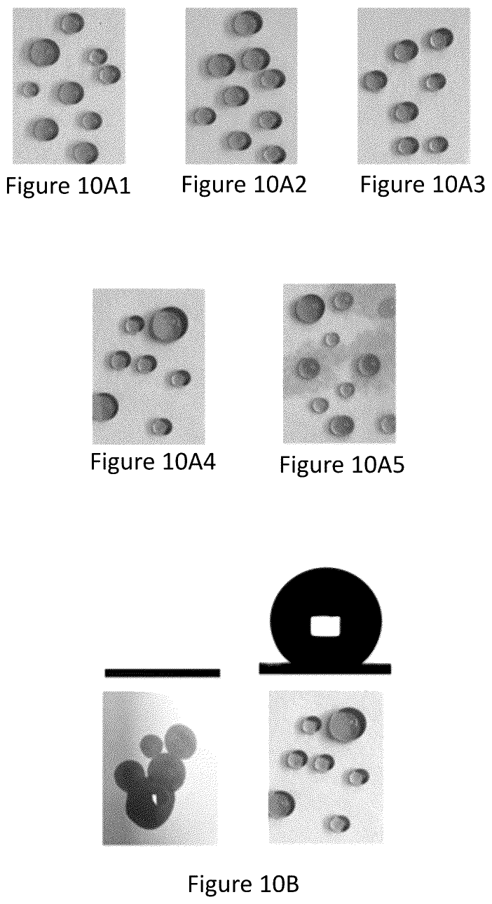

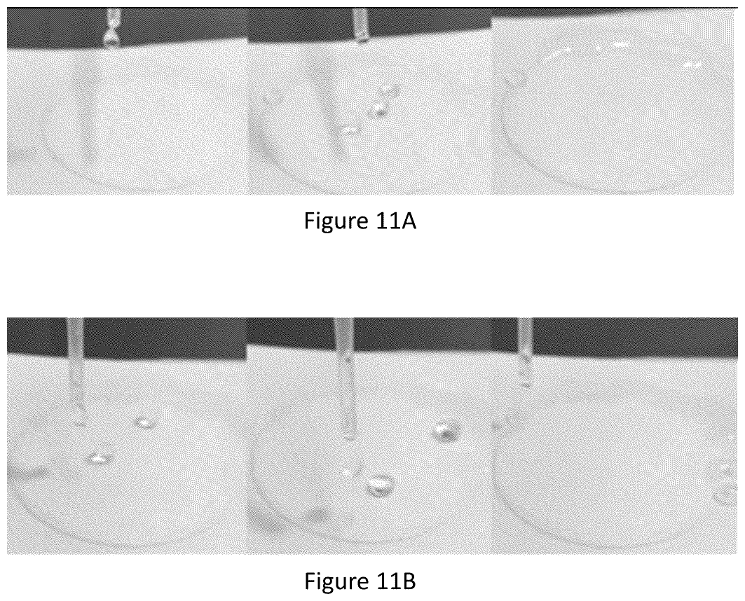

The wettability images of the superhydrophobic paper substrates treated by the exemplary emulsion of the invention, as compared to a control are presented in FIGS. 10A1-A5 and 10B.

### Example 3

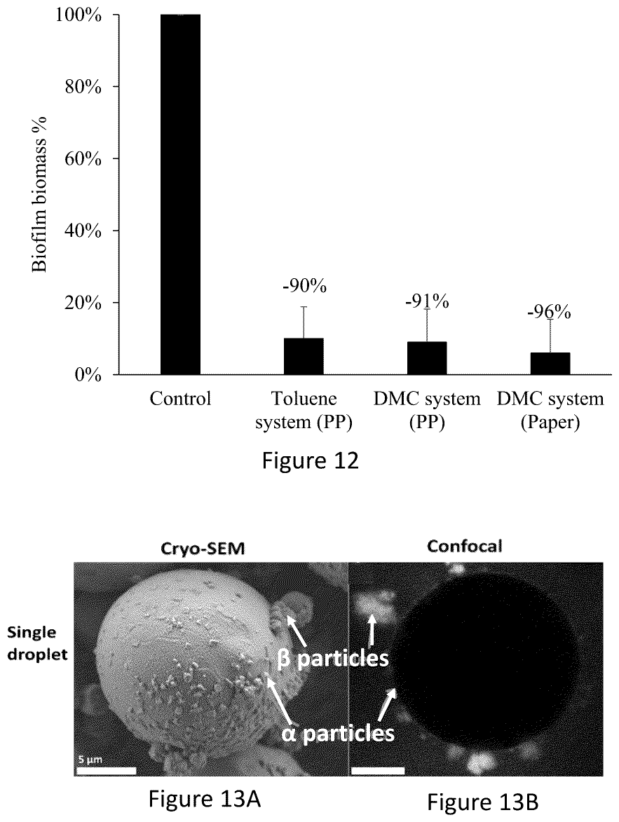

In order to assess the antibacterial properties of the coated films of the invention (comprising polypropylene, or paper substrates), the inventor studied E. coli biofilm formation on top of the coated films of the invention as compared to untreated control. The toluene-based composition of the invention reduced biofilm formation by 90%, the dimethyl carbonate based composition reduced biofilm formation by 91% (PP substrate), and 96% (paper) without additional active agents (see FIG. 12). Accordingly, it has been postulated that only the coating described herein (without any active agent, such as an antimicrobial agent) is responsible for the anti-microbial activity of the coated films of the invention.

### Example 4

### Super-Hydrophobic Coating Mechanical and Physical Properties

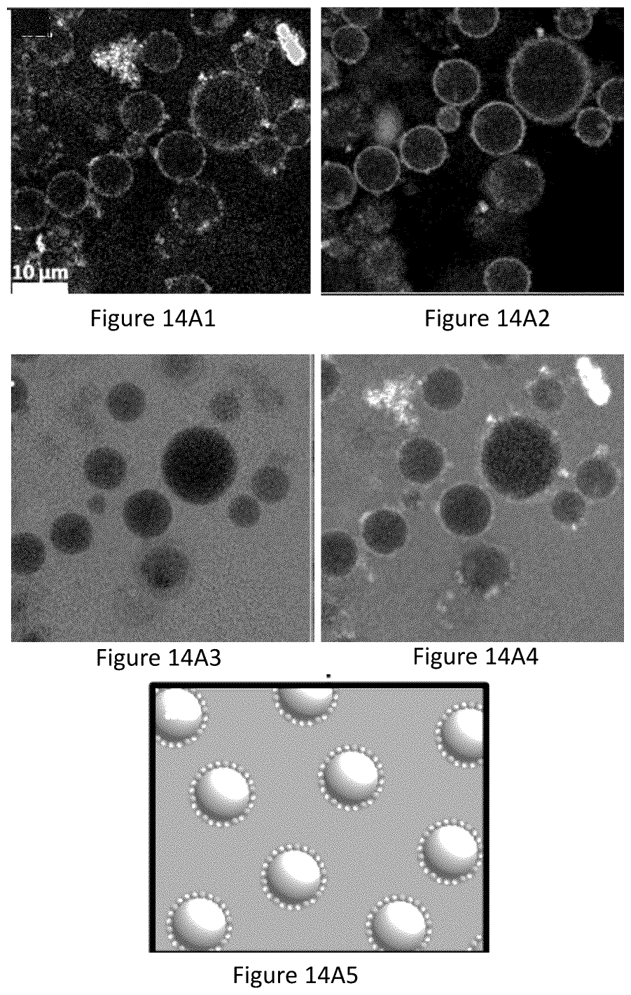

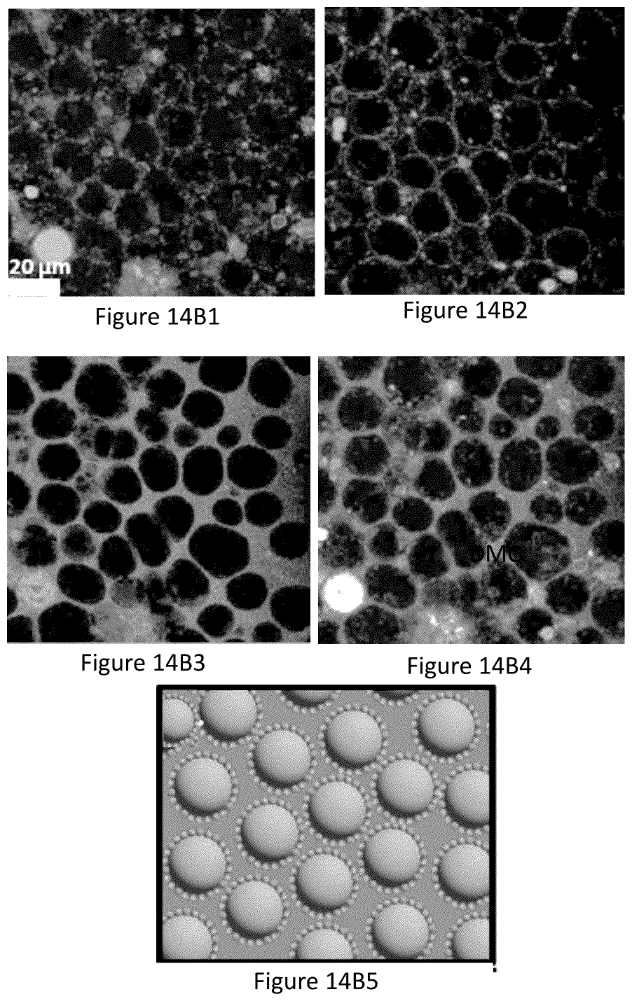

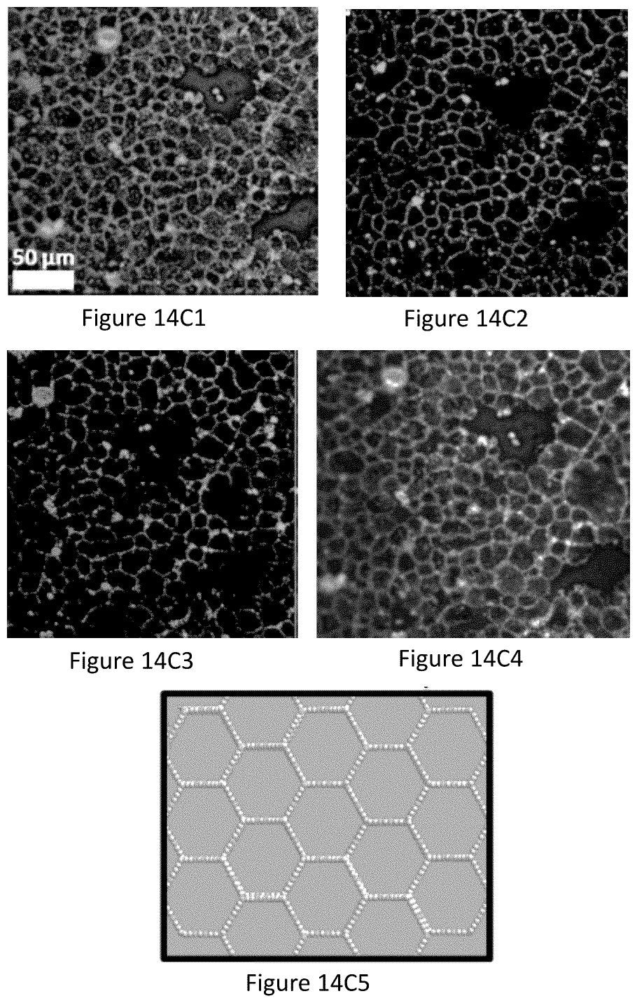

In addition, the inventors examined the templating pattern of the Super-hydrophobic coating (SHC) on a glass surface. 5 μl of the exemplary composition of the invention labeled with the fluorescent dyes (see above) was applied on a glass slide. Confocal microscopy images have been taken at different time intervals (i.e., immediately after the application, after 30 second and after 60 and seconds). FIGS. 14A1-A5, 14B1-B5 and 14C1-C5 show newly deposited drops, 30 seconds after deposition, and 60 seconds after deposition, respectively and accompanied by a scheme depicting each step of the coating layer formation. The first 30 seconds (FIGS. 14A, 14B) are mainly characterized by solvent evaporation, followed by evaporation of both solvent and water (FIG. 14C). By maintaining their volume throughout the first 30 seconds, adjacent droplets come together, linked by latex particles. Particle bridging is essential for preventing sides from collapsing, thereby maintaining hexagonal patterns as water evaporates almost completely.

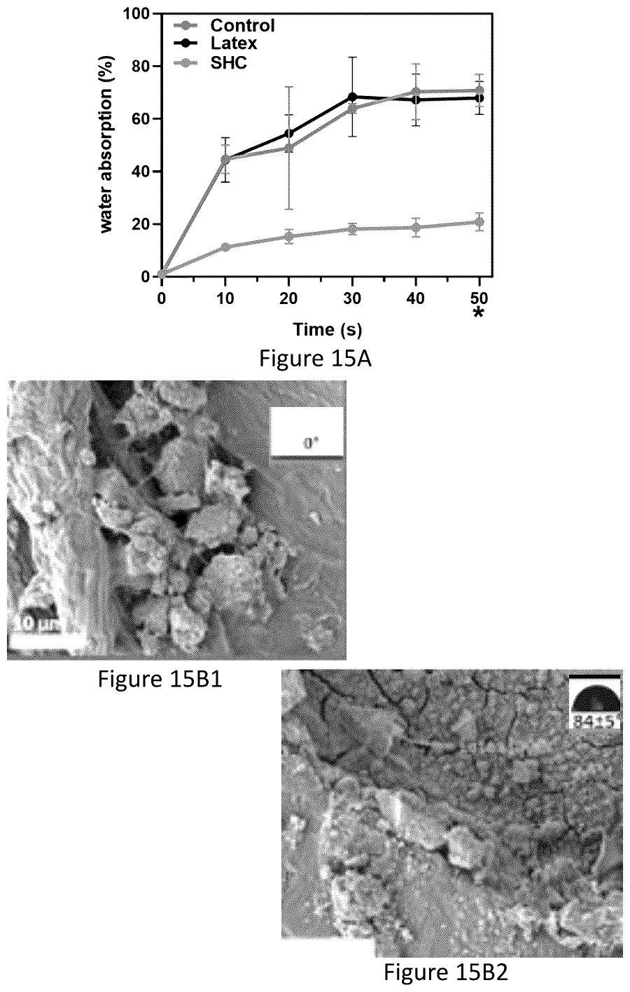

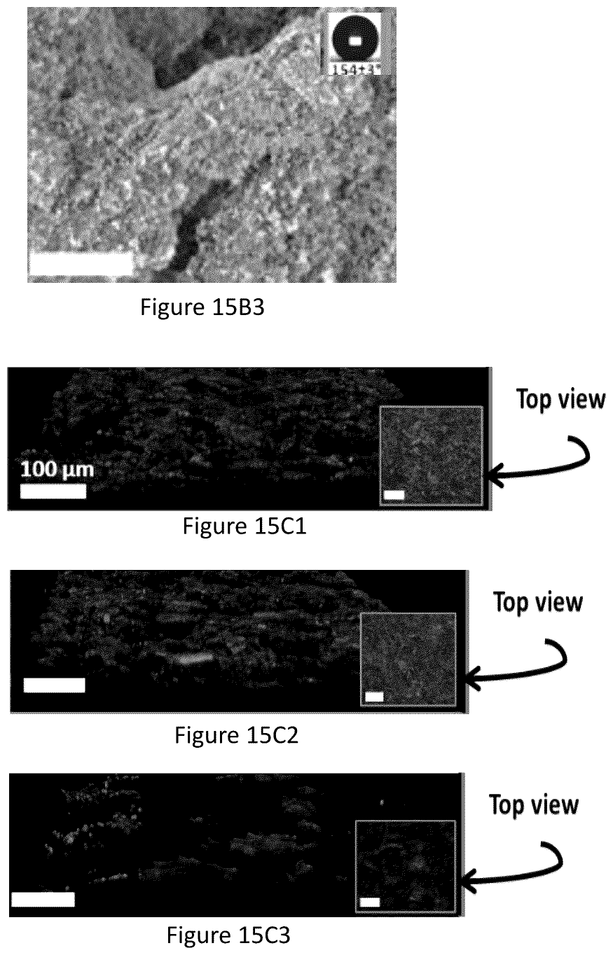

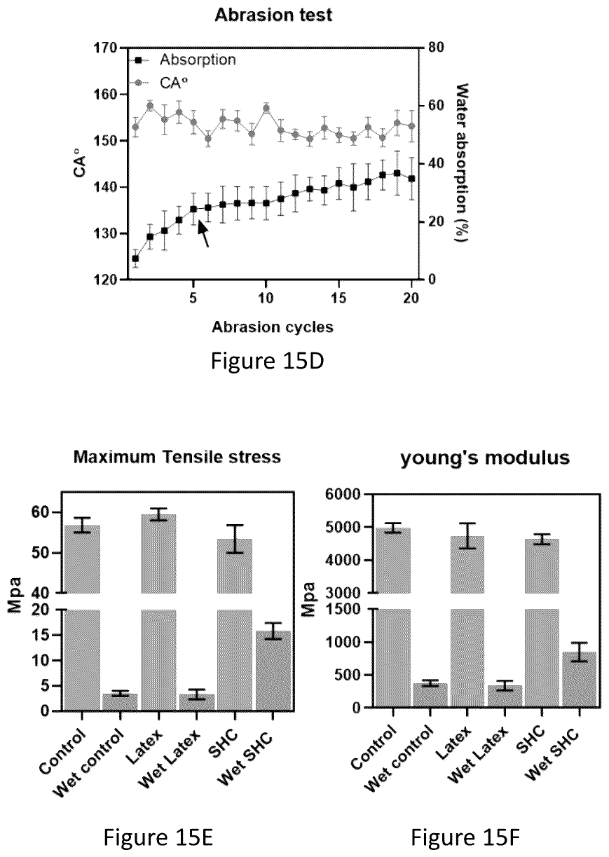

The inventors have tested exemplary coatings of the invention for water repellency and mechanical properties, and coating durability after numerous abrasion cycles (FIG. 15A). The obtained values were compared to uncoated paper and latex coated paper as control groups (FIG. 15A).

First, the three sample groups were evaluated for their water absorption after one coating layer on each side (˜3 μm) (FIG. 15A). Samples were submersed for 10 seconds 5 times (50 s total) and measured for their weight. No significant differences in absorption were observed after 50s submersion between control and latex groups at 71%±6.16 and 67%±6.24 respectively. Moreover, the addition of hydrophobic silica contributed to the water repellency of the coating, resulting in only low weight gain (about 21%) after submersion. These results were visually demonstrated by confocal images (FIGS. 15C1-C3) where after 50 s submersion in water/fluorescent-dye, SHC (15C3) showed very low fluorescence compared to both uncoated control (15C1) and latex (15B1) groups.

FIGS. 15B1-B3 include SEM micrographs showing that the latex layer provides full coverage of the paper surface (FIG. 15B2) and that the silica particles were largely located at the uppermost part of the coating (FIG. 15B3).

In addition, measured static contact angles (CAs) were not necessarily linked to the absorption capacity, as CAs of control, latex and the coating of the invention were 0°, 84±5° and 154±3° respectively. Depending on application, a degree of abrasion resistance while preserving functionality is essential in implementing coatings on an industrial scale. FIG. 15D demonstrates water absorption and CA vs 20 abrasion cycles of 60 gr load on sandpaper (No. 36). Abrasion tests show that super hydrophobicity was maintained (>150°) after all 20 abrasion cycles. In addition, the average weight gain after 50s submersion reached 24±5.5 and 21±3.3 for the scraped and untouched samples respectively. The robustness of the coating can be attributed to the acrylic latex, which is designed to serve as an industrial sealer and adhesive with self-crosslinking properties.

Mechanical analysis of wet (FIGS. 15E-15F red columns) and dry (FIGS. 15E-15F blue columns) papers of the three sample groups has been performed in order to establish a correlation between mechanical properties and water absorption presented in FIG. 15A. As presented in FIG. 15D, the highest average maximum tensile stress (59.5±1.4 MPa) has been recorder for dry latex coating. However, when testing the average maximum tensile stress of the wet samples, glass substrate coated according to the invention showed a ˜4.5 fold increase compared to both control and latex groups (the measured values were as follows: 15.7±1.5 for the coated substrate according to the invention, 3.5±0.4 and 3.2±0.9 MPa for the control and latex groups respectively. Without being bound to any particular theory, it is postulated that penetration of water into the paper substrate weakens the hydrogen bonds between fibers, causing them to swell and ultimately causing them to fail. Difference in strength can be seen in the samples young's modulus (FIG. 15E) as it reflects the applied stress per surface area.

SHC paper significantly improved its ability to withhold higher stress loads after being wetted. Interestingly, the inventors were able to minimize the stiffening and reduction of mechanical properties that are common in the solvent-based coating of papers substrates.

The wetting properties of the SHC were further evaluated, such as its behavior against various water temperatures, acidic and alkaline water drops as well as other interactions which provide clearer assessment regarding the coating.

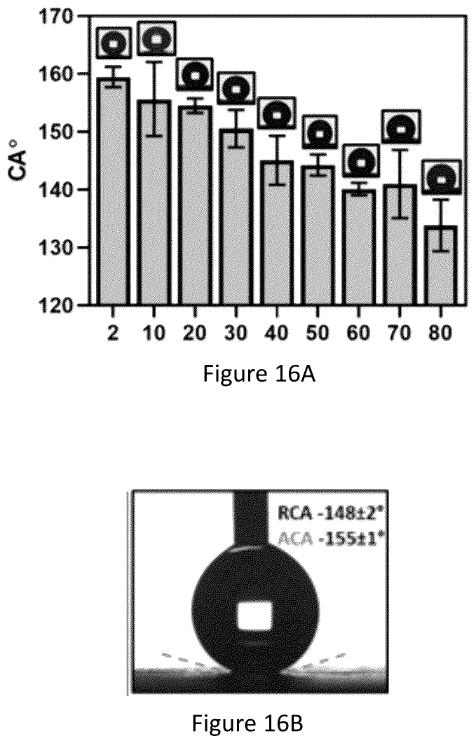

FIG. 16A demonstrates a negative correlation between static contact angle (CA) and temperature of a deposited drop on the surface. Mean CA value of water drops above 40° C. was reduced to about 145°.

This correlation could be explained by vapor accumulating at the air pockets between surface and water, which reduces the CA of the coated surface. FIG. 16B demonstrates advancing (ACA) and receding (RCA) contact angles measurements by increasing and decreasing drop volume at 0° angle respectively.

### Example 5

### Super-Hydrophobic Antimicrobial Evaluation

The inventors incorporated propolis (exemplary active agent) into the composition of the invention to gain anti-microbial properties in addition to the anti-biofilm properties which inherently characterizes the super-hydrophobic coatings of the invention (due to the prevention of bacterial attachment to the coated surface). The inventors utilized propolis extract in DMC, to substantially remove hydrocolloids and other hydrophilic particles, which might affect the superhydrophobic properties of the resulting coating.

The inventors extracted propolis by mixing it with DMC and subsequently centrifugating the mixture to obtain a clear supernatant. The resulting propolis solution in DMC was then used to prepare the coating composition of the invention.

Before evaluating the newly formed formulation for its anti-microbial capabilities, GCMS was performed in order to identify compounds within the coating. Table 4 shows the identified compounds and their relative concentration (%), based on peak area calculations. Interestingly, the propolis extract was largely composed of fatty aldehydes.

TABLE 4
Compound identification and their relative
concentration. Calculated based on GCMS.

| | | | Area | | | Prob. |
|---|---|---|---|---|---|---|
| Peak | RT | Area | (%) | Compound | Formula | (%) |
| 1 | 3.692 | 84311.63 | 9.5 | Silanediol, | C2H8O2Si | 98 |
| | | | | dimethyl- | | |
| 2 | 5.744 | 80692.08 | 9.1 | Octanal | C8H16O | 83 |
| 3 | 6.472 | 887176.68 | 100 | Nonanal | C9H18O | 72 |
| 4 | 7.128 | 113023.73 | 12.74 | Decanal | C10H20O | 40 |
| 5 | 7.723 | 81557.98 | 9.19 | Undecanal | C11H22O | 41 |
| 6 | 8.277 | 84851.96 | 9.56 | Dodecanal | C12H24O | 36 |
| 7 | 8.81 | 67435.62 | 7.6 | Tridecanal | C13H26O | 19 |
| 8 | 9.303 | 69801.14 | 7.87 | Tetradecanal | C14H28O | 50 |
| 9 | 9.774 | 135555.61 | 15.28 | 14-Octadecenal | C18H34O | 39 |
| 10 | 10.226 | 250344.44 | 28.22 | Isopropyl myristate | C17H34O2 | 74 |

In addition, the residual amount of DMC in the dry coating was determined by GCMS, results are summarized in Table 5.

TABLE 5
Identification of residual DMC (%) and in ppm/100
mg as a function of composition of the studied
coating and drying method using GCMS.

| Sample name/Drying method | DMC | Presence of DMC |
|---|---|---|
| (15 min) | (ppm/100 mg) | (%) |
| Coated paper/Oven | 8.7 ± 2.12 | 0.17 ± 0.016 |
| Coated paper/Hood | 17.4 ± 16.42 | 0.082 ± 0.068 |
| Coated paper + Propolis/Oven | 7.9 ± 6.05 | 0.092 ± 0.08 |
| Coated paper + Propolis/Hood | 0.8 ± 0.8 | 0.011 ± 0.011 |

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent, or patent application was specifically and individually indicated to be incorporated herein by reference. In addition, citation, or identification of any reference in this application shall not be construed as an admission that such reference is available as prior art to the present invention. To the extent that section headings are used, they should not be construed as necessarily limiting.

1. A composition, comprising a plurality of core-shell particles dispersed within a hydrophobic solvent, wherein:
a. the core of said core-shell particles comprises an aqueous solution;
b. the shell of said core-shell particles comprises hydrophobic metal oxide nanoparticles; and wherein the shell is in contact with polymeric particles;
c. a w/w ratio of said hydrophobic solvent to said aqueous solution within said composition is between 1:1 and 10:1; and
d. a w/w concertation of the hydrophobic metal oxide nanoparticles within said composition is between 0.5 and 5%;
e. an average cross-section of the core-shell particles is between 1 μm and 100 μm; and
f. the hydrophobic solvent is or comprises dimethyl carbonate (DMC).

2. The composition of claim 1, wherein a w/w concertation of the hydrophobic metal oxide nanoparticles within said composition is between 1.5 and 3%.

3. The composition of claim 1, wherein a ratio between the hydrophobic metal oxide nanoparticles and the polymeric particles is between 30:1 and 1:1.

4. The composition of claim 1, wherein a w/w concertation of the polymeric particles within the composition is between 0.05 and 2%; and wherein the polymeric particles are latex nanoparticles comprising a thermoplastic polymer characterized by a glass transition temperature between 1° and 90° C.

5. The composition claim 1, wherein an average cross-section of said polymeric particles is between 1 nm and 100 nm.

6. The composition claim 1, wherein said hydrophobic metal oxide nanoparticles comprise a chemical modification covalently attached to a metal oxide particle, the metal oxide particle is or comprises SiO₂ particle.

7. The composition of claim 6, wherein said chemical modification comprises any of a polysiloxane, a polysilane, (C1-C20)alkylsilyl group, a (C1-C20)alkoxysilane group including any copolymer or any combination thereof.

8. The composition of claim 7, wherein said polysiloxane is PDMS.

9. (canceled)

10. The composition of claim 4, wherein the thermoplastic polymer comprises a polyacrylate, a polyester, a polyurethane, polystyrene including any combination, or any copolymer thereof.

11. The composition claim 1, further comprising between 0.1 and 20% by weight of biologically active agent; and wherein said biologically active agent is selected from: an anti-microbial agent comprising an essential oil, a wax or both; a preservative; and a pesticide, or any combination thereof.

12. (canceled)

13. A coated substrate, comprising at least one surface of a substrate in contact with a coating, wherein:
a. the coating comprises a plurality of hollow microparticles;
b. a shell of the hollow microparticles comprises hydrophobic metal oxide nanoparticles and a thermoplastic polymer; and
c. a ratio between the hydrophobic metal oxide nanoparticles and the thermoplastic polymer within the shell is between 30:1 and 1:1.

14. The coated substrate of claim 13, wherein said thermoplastic polymer is in a form of latex particles; wherein the hydrophobic metal oxide nanoparticles are in contact with the latex particles, and wherein a weight ratio between the hydrophobic metal oxide nanoparticles and the latex particles within the coating is between 25:1 and 5:1; and wherein the coating is a water repellent coating; optionally wherein the coating is by any one of: anti-biofilm coating, anti-microbial coating, or both.

15. The coated substrate of claim 13, wherein the thermoplastic polymer comprises a polyacrylate, a polyester, a polyurethane, polystyrene including any combination, or any copolymer thereof; and wherein said hydrophobic metal oxide nanoparticles comprise chemically modified SiO₂ particles.

16. The coated substrate of claim 13, wherein the coated substrate is characterized by any one of: a roll-off angle between 0 and 10°; and a water contact angle of at least 120°; and wherein the substrate comprises a plastic substrate, a cellulose-based substrate, a glass substrate, a ceramic substrate, a metal substrate, a textile substrate, and a wood substrate or any combination thereof.

17. (canceled)

18. (canceled)

19. The coated substrate of claim 15, wherein said chemically modified SiO₂ particles are PDMS modified silica particles.

20. The coated substrate of claim 13, wherein the coating is in a form of a continuous layer, characterized by a thickness of between 0.5 and 50 um.

21. The coated substrate of claim 13, wherein an outer surface of the coated substrate is characterized by a route mean square of surface height (RMS) of between 20 and 100 nm.

22. (canceled)

23. The coated substrate of claim 14, wherein the latex particles are acrylate latex particles and are characterized by an average particle size between 1 and 100 nm; wherein the substrate is the cellulose-based substrate, and wherein the coated substrate is characterized by water absorption of at most 30% by weight of the substrate.

24. (canceled)

25. (canceled)

26. (canceled)

27. The coated substrate of claim 13, fabricated by applying the composition of claim 1 on top of the substrate; and exposing the substrate in contact with the composition under conditions suitable for drying, thereby obtaining the coated substrate.

28. The coated substrate of claim 27, wherein the conditions suitable for drying comprise a temperature between 1° and 200° C.
